(19) United States
(12) Patent Application Publication
(10) Pub. No.: US 2026/0337411 A1
(43) Pub. Date: Oct. 29, 2026

(54) THERMOPLASTIC MOULDING COMPOSITIONS HAVING AN IMPROVED COLOUR STABILITY-2

(71) Applicant: BASF SE, Ludwigshafen am Rhein (DE)

(72) Inventors: Tina Elisabeth KOLB, Ludwigshafen am Rhein (DE); Michael ROTH, Ludwigshafen am Rhein (DE)

(21) Appl. No.: 19/115,696

(22) PCT Filed: Sep. 25, 2023
(86) PCT No.: PCT/EP2023/076338

§ 371 Date: Mar. 26, 2025

(30) Foreign Application Priority Data
Sep. 27, 2022 (EP) 22197968.5

(51) Int. Cl. C08L 77/06; B29C 48/05; B29K 77/00; B29K 309/08; C08K 3/22; C08K 3/26; C08K 3/30; C08K 3/32; C08K 3/38; C08K 5/098; C08K 7/14; C08K 9/00

(52) U.S. Cl. CPC C08L 77/06; B29C 48/05; C08K 3/22; C08K 3/26; C08K 3/30; C08K 3/32; C08K 3/38; C08K 5/098; C08K 7/14; C08K 9/00; B29K 2077/00; B29K 2309/08; B29K 2995/002; C08K 2003/2224; C08K 2003/2227; C08K 2003/2296; C08K 2003/3036; C08K 2003/387; C08K 2201/003; C08K 2201/004; C08L 2203/20; C08L 2205/025

(57) ABSTRACT

A thermoplastic moulding composition comprising at least one thermoplastic polyamide, as component A), at least one of sodium hypophosphite or a hydrate of sodium hypophosphite, as component B), a colourant comprising at least one not covalently bonded sulfur atom or two or more colourants comprising at least one sulfur containing colourant comprising at least one not covalently bonded sulfur atom, as component C), and at least one acid scavenger, as component D); a process for producing the inventive thermoplastic moulding composition comprising the step of mixing the components A), B), C) and D); the use of the inventive thermoplastic moulding composition for producing moulded articles, fibres, films and extruded articles, preferably moulded articles, which are more preferably coloured and which are most preferably coloured orange; a moulded or extruded article made of the inventive thermoplastic moulding composition; the inventive moulded or extruded article being a high-voltage component; a process for producing the inventive moulded or extruded articles by injection moulding or extrusion of the inventive thermoplastic moulding composition; and the use of at least one acid scavenger in a thermoplastic moulding composition comprising i) at least one thermoplastic polyamide, ii) at least one of sodium hypophosphite or a hydrate of sodium hypophosphite and iii) a colourant comprising at least one not covalently bonded sulfur atom or two or more colourants comprising at least one sulfur containing colourant comprising at least one not covalently bonded sulfur atom, for improving the odour of said thermoplastic moulding composition.

The present invention relates to a thermoplastic moulding composition comprising at least one thermoplastic polyamide, as component A), at least one of sodium hypophosphite or a hydrate of sodium hypophosphite, as component B), a colourant comprising at least one not covalently bonded sulfur atom, or two or more colourants comprising at least one sulfur containing colourant comprising at least one not covalently bonded sulfur atom, as component C), and at least one acid scavenger, as component D); a process for producing the inventive thermoplastic moulding composition comprising the step of mixing the components A), B), C) and D); the use of the inventive thermoplastic moulding composition for producing moulded articles, fibres, films and extruded articles, preferably moulded articles, which are more preferably coloured and which are most preferably coloured orange; a moulded or extruded article made of the inventive thermoplastic moulding composition; the inventive moulded or extruded article being a high-voltage component; a process for producing the inventive moulded or extruded articles by injection moulding or extrusion of the inventive thermoplastic moulding composition; and the use of at least one acid scavenger in a thermoplastic moulding composition comprising i) at least one thermoplastic polyamide, ii) at least one of sodium hypophosphite or a hydrate of sodium hypophosphite and iii) of a colourant comprising at least one not covalently bonded sulfur atom or two or more colourants comprising at least one sulfur containing colourant comprising at least one not covalently bonded sulfur atom, for improving the odour of said thermoplastic moulding composition.

Among engineering plastics, polyamides are important materials particularly in the field of automotive applications due to the good mechanical and electrical properties as well as high chemical resistance. With the transfer from the internal combustion engine (ICE) to electrical engines (at least partly (hybrid vehicle [HEV, PHEV, BEV REX]) or completely (electromobile [BEV, FCEV]), new requirements for the materials used in automotive applications are coming up. For example, while in conventional automotives having an internal combustion engine (ICE) as their sole means of propulsion typically a 12 V on-board voltage system is sufficient, hybrid and electric vehicles having electric motors as a drive unit require significantly higher voltages. Engineers need to meet strict design parameters for dielectric strength, creeping, tracking resistance and the ability to colour code various electrical systems. The orange colour selected for the high-voltage systems and main battery charging path helps operators and rescue teams enable safe handling, either during maintenance or in the event of an accident. It is crucial that the orange colour is maintained over the lifetime of the hybrid or electric automotive.

Since polyamide in general is prone to thermo-oxidative degradation, a yellowing-up on heat treatment occurs. This also affects the colour of products, e.g. of orange-coloured products.

In the art there are suggestions to delay the thermo-oxidative degradation by adding known heat stabilizers comprising H-donors, hydroperoxide decomposers, alkyl radical scavengers and metal deactivators. An overview of the different classes of heat stabilizers can be found in the Plastic Additives Handbook, Chapter 1 (p. 3-19), edited by Hans Zweifel (fifth edition, Carl Hanser Verlag, Munich). Often used systems are sterically hindered phenolic antioxidants optionally in combination with organic triaryl phosphite. Improved colour (i.e. reduced yellowness) can be further attained in polyamides by using certain phosphorous compounds. The phosphorous compounds serve as colour stabilizers for the polyamides by reducing the degree of oxidative and thermal degradation and can be added during polymerization or in the compounding step. As phosphorous compounds sodium hypophosphite can be used (see the European patent application “Thermoplastic moulding compositions having an improved colour stability” filed on the same day by the same applicant as the present application).

Many colourants, (including colourants resulting in the colour orange) comprise sulfur which is not exclusively covalently bonded, i.e. being able to release hydrogen sulfide (e.g. zinc sulfide, cerium sulfide, cerium sulfide/lanthanum sulfide) in the presence of acidic compounds (e.g. degradation products of sodium hypophosphite). The hydrogen sulfide causes a strong smell and also constitutes a serious environmental and health hazard.

However, the problem of the release of hydrogen sulfide in polyamide compositions comprising compounds comprising at least one not covalently bonded sulfur atom (e.g. colourants like zinc sulfide, cerium sulfide, cerium sulfide/lanthanum sulfide) and acidic compounds (e.g. derived from sodium hypophosphite) is not addressed in the related art.

This combination of the presence compounds comprising at least one not covalently bonded sulfur atom in polyamide compositions especially arises in coloured (especially orange) polyamide compositions, since a number of colourants comprise compounds being able to release hydrogen sulfide under acidic conditions.

It is therefore an object of the present application to provide thermoplastic moulding compositions having a high colour stability, especially coloured thermoplastic moulding compositions, especially at high temperatures, which compositions comprise no or a reduced hydrogen sulfide smell.

The object is achieved by a thermoplastic moulding composition comprising
a) from 10 to 99.97% by weight of at least one thermoplastic polyamide different from component E), as component A),
b) from 0.01 to 0.5% by weight of at least one of sodium hypophosphite or a hydrate of sodium hypophosphite, as component B),
c) from 0.01 to 5% by weight of a colourant comprising at least one not covalently bonded sulfur atom or two or more colourants comprising at least one sulfur containing colourant comprising at least one not covalently bonded sulfur atom, preferably an orange colourant comprising at least one not covalently bonded sulfur atom or two or more colourants resulting in the colour orange comprising at least one sulfur containing colourant comprising at least one not covalently bonded sulfur atom, with particular preference for shades corresponding in the RAL colour system to the colour numbers RAL 2001, RAL 2003, RAL 2004, RAL 2007, RAL 2008, RAL 2009, RAL 2010 and RAL 2011, and very particular preference for the shades corresponding in the RAL colour system to the colour numbers RAL 2003, RAL 2008 and RAL 2011, as component C),
d) from 0.01 to 2% by weight of at least one acid scavenger, as component D),
e) from 0 to 20% by weight of at least one polyamide 6I/6T, as component E),
f) from 0 to 5% by weight of at least one laser inscription additive, preferably at least one pigment system comprising a metal oxide or a mixture of two or more metal oxides, more preferably antimony trioxide, titanium dioxide, glimmer, tin oxide, ferrous oxide, zinc oxide, aluminum oxide, bismuth trioxide, or mixtures thereof, as component F),
g) from 0 to 60% by weight of at least one fibrous and/or particulate filler, as component G),
h) from 0 to 55% by weight of at least one flame retardant additive, as component H), and
i) from 0 to 25% by weight of at least one further additive, as component I),
where the total of the percentages by weight of components A) to I) is 100% by weight.

The amount of component B), calculated on sodium is 0.002 to 0.11% by weight, in the case that sodium hypophosphite monohydrate is used. In the case that sodium hypophosphite is used, the amount of sodium is 0.0026 to 0.13% by weight.

The object is further achieved by a process for producing the inventive thermoplastic moulding composition comprising the step of mixing the components, A), B), C), D), optionally E), optionally F), optionally G), optionally H) and optionally I).

The object is further achieved by the use of the inventive thermoplastic moulding composition or the thermoplastic moulding composition obtained by the inventive process for producing fibres, foils, moulded articles and extruded articles.

The object is further achieved by a fibre, a foil, a moulded article or extruded article made of the inventive thermoplastic moulding composition or the thermoplastic moulding composition obtained by the inventive process.

The object is further achieved by a process for producing the inventive fibres, foils, moulded or extruded articles by injection moulding, extrusion or blow moulding of the inventive thermoplastic moulding composition or thermoplastic moulding composition obtained by the inventive process.

The object is further achieved by the use of at least one acid scavenger in a thermoplastic moulding composition comprising i) at least one thermoplastic polyamide, ii) at least one of sodium hypophosphite or a hydrate of sodium hypophosphite and iii) a colourant comprising at least one not covalently bonded sulfur atom or two or more colourants comprising at least one sulfur containing colourant comprising at least one not covalently bonded sulfur atom, for improving the odour of said thermoplastic moulding compositions.

The following has been found by the inventors:
Polyamide compositions having a very high colour stability can be obtained by employing at least one of sodium hypophosphite or a hydrate of sodium hypophosphite. However, if at least one colourant comprising at least one not covalently bonded sulfur atom is present in the compositions, e.g. sulfides like zinc sulfide, cerium sulfide, cerium sulfide/lanthanum sulfide, hydrogen sulfide is released causing a strong smell and also constitutes a serious environmental and health hazard, due to acidic components generated for example during the melt compounding process in the presence of sodium hypophosphite. It has been found that the release of hydrogen sulfide can be suppressed by the addition of an acid scavenger into said polyamide composition.

In the meaning of the present application an improved “colour stability” means an improved colour stability on storage. The colour stability is tested by observing the YI (yellowness index) values for uncoloured products or ΔE (colour distance) values for coloured products at indicated time intervals and elevated temperature.

The inventive thermoplastic moulding compositions are especially suitable for the provision of orange-coloured compositions for high-voltage applications, especially in automotives.

In the case of orange-coloured inventive thermoplastic moulding compositions, the colour distance ΔE after 1000 h at 120° C. is preferably <20 from the L*a * b coordinates of a colour number beginning with “2” in the RAL colour chart, preferably a ΔE<10, more preferably ΔE<5.

The thermoplastic moulding compositions of the present invention are especially suitable for use in/as high-voltage components, especially high-voltage components in automotive applications.

The term “high-voltage” is according to the present invention to be understood as a working voltage of >30 V (direct current) or >20 V (alternating current), preferably >60 V (direct current) or >30 V (alternating current). “High-voltage components” according to the present invention are therefore components, preferably components for electromobility, subjected to an operating (working) voltage of >30 V, preferably >60 V (direct current) or >20 V, preferably >30 V (alternating current).

According to ISO 6469-3:2021, the outer covering of cables and harness for high-voltage electric circuits not within enclosures or behind barriers shall be marked with orange colour.

In the context of the present invention, “at least one” means either exactly one or a mixture of two or more different components.

### Component A)

As component A), the thermoplastic moulding composition contains 10 to 99.97% by weight, preferably 20 to 85% by weight, more preferably 30 to 75% by weight, based on the total amount of components A), B), C), D), optionally E), optionally F), optionally G), optionally H) and optionally I), of at least one thermoplastic polyamide different from component E) (as mentioned below).

If components E, F, G, H or I, or combinations thereof are present in the thermoplastic moulding composition, the maximum amount of component A) is decreased by the minimum amount of each of components E, F, G, H or I, or a combination thereof.

The polyamides A) of the inventive moulding compositions generally have a viscosity number of 90 to 350 ml/g, preferably from 100 to 240 ml/g. The viscosity number (VN) of the polyamides and polyamide compositions according to the present invention is determined according to EN ISO 307:2019 in sulfuric acid (0.5% [m/v] of polyamide in 96 wt.-% [m/m] sulfuric acid at 25° C.), unless indicated otherwise.

Preference is given to semicrystalline or amorphous polyamides with a molecular weight (weight average) of at least 5000, described by the way of example in the following US patents: 2071250, 2071251, 2130523, 2130948, 2241322, 2312966, 2512606, and 3393210.

Examples of these are polyamides that derive from lactams having from 7 to 13 ring members, e.g. polycaprolactam, polycaprylolactam, and polylaurolactam, and also polyamides obtained via reaction of dicarboxylic acids with diamines.

Dicarboxylic acids which may be used are alkane dicarboxylic acids having from 6 to 12, in particular from 6 to 10 carbon atoms, and aromatic dicarboxylic acids. Merely as examples, those that may be mentioned here are adipic acid, azelaic acid, sebacic acid, dodecanedioic acid and terephthalic and/or isophthalic acid.

Particularly suitable diamines are alkane diamines having from 6 to 12, in particular 6 to 8 carbon atoms, and also m-xylylene diamine, di [4-aminophenyl]methane, di [4-aminocyclohexyl]methane, 2,2-di [4-aminophenyl]propane, 2,2-di [4-aminocyclohexyl]propane and 1,5-diamino-2-methylpantane.

Preferred polyamides are polyhexamethylene adipamid, polyhexamethylene sebacamid, and polycaprolactam, and also PA 6/66 copolyamides, in particular having a proportion of 5 to 95 wt % of caprolactam units (e.g. Ultramid® C31 from BASF SE).

Other suitable polyamides are obtainable from ω-aminoalkyl nitriles, e.g. aminocapronitrile (PA 6) and adiponitrile with hexamethylene diamine (PA 66) via what is known as direct polymerization in the presence of water, for example as described in DE-A 10313681, EP-A 1198491 and EP 0 922 065.

Mention may also be made of polyamides obtainable, by way of example, via condensation of 1,4-diaminobutane with adipic acid at an elevated temperature (PA 46). Preparation processes for polyamides of this structure are described by way of example in EP-A 38094, EP-A 38582, and EP-A 39524.

Other suitable examples are polyamides obtainable via copolymerization of two or more of the above-mentioned monomers, and mixtures of two or more polyamides in any desired mixing ratio. Particular preference is given to mixtures of PA 66 with other polyamides, in particular blends of PA 6 and PA 66, and to PA6/66 copolyamides and PA 66/6 copolyamides.

Other copolyamides which have proven particularly advantageous are semiaromatic copolyamides, such as PA 6/6T and PA 66/6T, where the triamine content of these is preferably less than 0.5 wt %, more preferably less than 0.3 wt % (see EP-A 299444). Other polyamides resistant to high temperatures are known from EP-A 1994075 (PA 6T/6I/MXD6).

The processes described in EP-A 129195 and EP-A 129196 can be used to prepare the preferred semiaromatic copolyamides with low triamine content.

The following list, which is not comprehensive, comprises polyamides A) mentioned above and other polyamides A) useful for the purposes of the present invention, and the monomers comprised:

### AB Polymers:

| | |
|---|---|
| PA 4 | Pyrrolidone |
| PA 6 | ε-Caprolactam |
| PA 7 | Ethanolactam |
| PA 8 | Caprylolactam |
| PA 9 | 9-Aminopelargonic acid |
| PA 11 | 11-Aminoundecanoic acid |
| PA 12 | Laurolactam |

### AA/BB Polymers:

| | |
|---|---|
| PA 46 | Tetramethylenediamine, adipic acid |
| PA 66 | Hexamethylenediamine, adipic acid |
| PA 69 | Hexamethylenediamine, azelaic acid |
| PA 610 | Hexamethylenediamine, sebacic acid |
| PA 612 | Hexamethylenediamine, decanedicarboxylic acid |
| PA 613 | Hexamethylenediamine, undecanedicarboxylic acid |
| PA 1212 | 1,12-Dodecanediamine, decanedicarboxylic acid |
| PA 1313 | 1,13-Diaminotridecane, undecanedicarboxylic acid |
| PA 6T | Hexamethylenediamine, terephthalic acid |
| PA MXD6 | m-Xylylenediamine, adipic acid |

### AA/BB Polymers:

| | |
|---|---|
| PA 6I | Hexamethylenediamine, isophthalic acid |
| PA 6-3-T | Trimethylhexamethylenediamine, terephthalic acid |
| PA 6/6.36 | (see below) |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 6I and PA 6T) |
| PA PACM 12 | Diaminodicyclohexylmethane, laurolactam |
| PA 6I/6T/PACM | as PA 6I/6T + diaminodicyclohexylmethane |
| PA 12/MACMI | Laurolactam, dimethyldiaminodicyclohexylmethane, |
| | isophthalic acid |
| PA 12/MACMT | Laurolactam, dimethyldiaminodicyclohexylmethane, |
| | terephthalic acid |
| PA PDA-T | Phenylenediamine, terephthalic acid |

Preferred polyamides A) are PA 6, PA 66, PA 46, PA 6/66, PA 66/6, PA 6/636, PA 6T/6, PA 6T/6I, PA 6T/6I/66, PA 9T, PA 6T/66 or mixtures thereof.

Most preferred are PA 6, PA 66, PA 6/66 and PA 66/6 as well as PA 6/636, or mixtures thereof. Most preferred are PA 6, PA 66 or mixtures thereof.

Suitable copolyamides are constructed from:
A1) 20.0 to 90.0 wt % of units derived from terephthalic acid and hexamethylene diamine,
A2) 0 to 50.0 wt % of units derived from ¿-caprolactam,
A3) 0 to 80.0 wt % of units derived form adipic acid and hexamethylene diamine,
A4) 0 to 40.0 wt % of further polyamide-forming monomers,
wherein the proportion of component A2) or A3) or A4), or mixtures thereof is at least 10.0 wt %.

Component A1) comprises 20.0 to 90.0 wt % of units derived from terephthalic acid and hexamethylene diamine.

In addition to the units derived from terephthalic acid and hexamethylene diamine, the copolyamides optionally comprise units derived from ε-caprolactam and/or units derived from adipic acid and hexamethylene diamine and/or units derived from further polyamide-forming monomers.

Aromatic dicarboxylic acids A4) comprise 8 to 16 carbon atoms. Suitable aromatic dicarboxylic acids include for example isophthalic acid, substituted terephthalic and isophthalic acids, such as 3t-butylisophthalic acid, polycyclic dicarboxylic acids, for example 4,4′- and 3,3′-diphenyldicarboxylic acid, 4,4′- and 3,3′-diphenylmethanedicarboxylic acid, 4,4′- and 3,3′-sulfodiphenylcarboxylic acid, 1,4- or 2,6-naphthalenedicarboxylic acid, phenoxyterephthalic acid, whereby isophthalic acid is particularly preferred.

Further, polyamide-forming monomers A4) may be derived from dicarboxylic acids having 4 to 16 carbon atoms and aliphatic or cycloaliphatic diamines having 4 to 16 carbon atoms, and also from aminocarboxylic acids/corresponding lactams having 7 to 12 carbon atoms. Examples of suitable monomers of these types are suberic acid, azelaic acid and sebacic acid as representatives of aliphatic dicarboxylic acids, 1,4-butanediamine, 1,5-pentandiamine, piperazine, 4,4′-diaminodicyclohexylmethane, 2,2-(4,4′-diaminodicyclohexylpropane) and 3,3′-dimethyl-4,4′-diaminodicyclohexylmethane or meta-xylylenediamine as representatives of diamines and caprolactam, enantholactam, ω-aminoundecanoic acid and laurolactam as representatives of lactams/aminocarboxylic acids.

Examples for such copolyamides are more particularly elucidated in DE-A 10 2009 011668.

As component A) the thermoplastic moulding materials can comprise at least one copolyamide produced by polymerization of the components
A′) 15% to 84% by weight of at least one lactam,
B′) 16% to 85% by weight of a monomer mixture (M) comprising the components
   B1′) at least one C₃₂-C₄₀-dimer acid and
   B2′) at least one C₄-C₁₂-diamine,
wherein the percentages by weight of the components A′) and B′) are in each case based on the sum of the percentages by weight of the components A′) and B′).

In the context of the present invention the terms “component A′)” and “at least one lactam” are used synonymously and therefore have the same meaning.

The same applies for the terms “component B′)” and “monomer mixture (M)”. These terms are likewise used synonymously in the context of the present invention and therefore have the same meaning.

According to the invention the at least one copolyamide is produced by polymerization of 15% to 84% by weight of the component A′) and 16% to 85% by weight of the component B′), preferably by polymerization of 40% to 83% by weight of the component A′) and 17% to 60% by weight of the component B′) and especially preferably by polymerization of 60% to 80% by weight of the component A′) and 20% to 40% by weight of the component B′), wherein the percentages by weight of the components A′) and B′) are in each based on the sum of the percentages by weight of the components A′) and B′).

The sum of the percentages by weight of the components A′) and B′) is preferably 100% by weight.

It will be appreciated that the weight percentages of the components A′) and B′) relate to the weight percentages of the components A′) and B′) prior to the polymerization, i.e. when the components A′) and B′) have not yet reacted with one another. During the polymerization of the components A′) and B′) the weight ratio of the components A′) and B′) may optionally change.

According to the invention the at least one copolyamide is produced by polymerization of the components A′) and B′). The polymerization of the components A′) and B′) is known to those skilled in the art. The polymerization of the components A′) with B′) is typically a condensation reaction. During the condensation reaction the component A′) reacts with the components B1′) and B2′) present in the component B′) and optionally with the component B3′) described hereinbelow which may likewise be present in the component B′). This causes amide bonds to form between the individual components. During the polymerization the component A′) is typically at least partially in open chain form, i.e. in the form of an amino acid.

The polymerization of the components A′) and B′) may take place in the presence of a catalyst. Suitable catalysts include all catalysts known to those skilled in the art which catalyze the polymerization of the components A′) and B′). Such catalysts are known to those skilled in the art. Preferred catalysts are phosphorus compounds, for example sodium hypophosphite, phosphorous acid, triphenylphosphine or triphenyl phosphite.

The polymerization of the components A′) and B′) forms the at least one copolyamide which therefore comprises units derived from the component A′) and units derived from the component B′). Units derived from the component B′) comprise units derived from the components B1′) and B2′) and optionally from the component B3′).

The polymerization of the components A′) and B′) forms the copolyamide as a copolymer. The copolymer may be a random copolymer. It may likewise be a block copolymer.

Formed in a block copolymer are blocks of units derived from the component B′) and blocks of units derived from the component A′). These appear in alternating sequence. In a random copolymer units derived from the component A′) alternate with units derived from the component B′). This alternation is random. For example two units derived from the component B′) may be followed by one unit derived from the component A′) which is followed in turn by a unit derived from the component B′) and then by a unit comprising three units derived from the component A′).

It is preferable when the at least one copolyamide is a random copolymer.

Production of the at least one copolyamide preferably comprises steps of:
I) polymerizing the components A′) and B′) to obtain at least a first copolyamide,
II) pelletizing the at least one first copolyamide obtained in step I) to obtain at least one pelletized copolyamide,
III) extracting the at least one pelletized copolyamide obtained in step II) with water to obtain at least one extracted copolyamide,
IV) drying the at least one extracted copolyamide obtained in step III) at a temperature (TT) to obtain the at least one copolyamide,

The polymerization in step I) may be carried out in any reactor known to those skilled in the art. Preference is given to stirred tank reactors. It is also possible to use auxiliaries known to those skilled in the art, for example defoamers such as polydimethylsiloxane (PDMS), to improve reaction management.

In step II) the at least one first copolyamide obtained in step I) may be pelletized by any methods known to those skilled in the art, for example by strand pelletization or underwater pelletization.

The extraction in step III) may be effected by any methods known to those skilled in the art.

During the extraction in step III) byproducts typically formed during the polymerization of the components A′) and B′) in step I) are extracted from the at least one pelletized copolyamide.

In step IV) the at least one extracted copolyamide obtained in step III) is dried. Processes for drying are known to those skilled in the art. According to the invention the at least one extracted copolyamide is dried at a temperature (T_{T}). The temperature (T_{T}) is preferably above the glass transition temperature (T_{G(C)}) of the at least one copolyamide and below the melting temperature (T_{M(C)}) of the at least one copolyamide.

The drying in step IV) is typically carried out for a period in the range from 1 to 100 hours, preferably in the range from 2 to 50 hours and especially preferably in the range from 3 to 40 hours.

It is thought that the drying in step IV) further increases the molecular weight of the at least one copolyamide.

The at least one copolyamide typically has a glass transition temperature (T_{G(C)}). The glass transition temperature (T_{G(C)}) is for example in the range from 20° C. to 50° C., preferably in the range from 23° C. to 47° C. and especially preferably in the range from 25° C. to 45° C. determined according to ISO 11357-2:2014.

In the context of the present invention the glass transition temperature (T_{G(C)}) of the at least one copolyamide is based, in accordance with ISO 11357-2:2014, on the glass transition temperature (T_{G(C)}) of the dry copolyamide.

In the context of the present invention “dry” is to be understood as meaning that the at least one copolyamide comprises less than 1% by weight, preferably less than 0.5% by weight and especially preferably less than 0.1% by weight of water based on the total weight of the at least one copolyamide. “Dry” is more preferably to be understood as meaning that the at least one copolyamide comprises no water and most preferably that the at least one copolyamide comprises no solvent.

In addition, the at least one copolyamide typically has a melting temperature (T_{M(C)}). The melting temperature (T_{M(C)}) of the at least one copolyamide is, for example, in the range from 150 to 210° C., preferably in the range from 160 to 205° C. and especially preferably in the range from 160 to 200° C. determined according to ISO 11357-3:2014.

The at least one copolyamide generally has a viscosity number (V_{N(C)}) in the range from 150 to 300 ml/g determined in a 0.5% by weight solution of the at least one copolyamide in a mixture of phenol/o-dichlorobenzene in a weight ratio of 1:1.

It is preferable when the viscosity number (V_{N(C)}) of the at least one copolyamide is in the range from 160 to 290 mL/g and particularly preferably in the range from 170 to 280 mL/g determined in a 0.5% by weight solution of the at least one copolyamide in a mixture of phenol/o-dichlorobenzene in a weight ratio of 1:1.

### Component A′)

According to the invention the component A′) is at least one lactam.

In the context of the present invention “at least one lactam” is understood as meaning either precisely one lactam or a mixture of 2 or more lactams.

Lactams are known per se to those skilled in the art. Preferred according to the invention are lactams having 4 to 12 carbon atoms.

In the context of the present invention “lactams” are to be understood as meaning cyclic amides having preferably 4 to 12 carbon atoms, particularly preferably 5 to 8 carbon atoms, in the ring.

Suitable lactams are for example selected from the group consisting of 3-aminopropanolactam (propio-3-lactam; β-lactam; β-propiolactam), 4-aminobutanolactam (butyro-4-lactam; γ-lactam; γ-butyrolactam), aminopentanolactam (2-piperidinone; δ-lactam; δ-valerolactam), 6-aminohexanolactam (hexano-6-lactam; ε-lactam; ε-caprolactam), 7-aminoheptanolactam (heptano-7-lactam; ζ-lactam; ζ-heptanolactam), 8-aminooctanolactam (octano-8-lactam; η-lactam; n-octanolactam), 9-aminononanolactam (nonano-9-lactam; θ-lactam; θ-nonanolactam), 10-aminodecanolactam (decano-10-lactam; ω-decanolactam), 11-aminoundecanolactam (undecano-11-lactam; ω-undecanolactam) and 12-aminododecanolactam (dodecano-12-lactam; ω-dodecanolactam).

The present invention therefore also provides a process where the component A′) is selected from the group consisting of 3-aminopropanolactam, 4-aminobutanolactam, 5-aminopentanolactam, 6-aminohexanolactam, 7-aminoheptanolactam, 8-aminooctanolactam, 9-aminononanolactam, 10-aminodecanolactam, 11-aminoundecanolactam and 12-aminododecanolactam.

The lactams may be unsubstituted or at least monosubstituted. If at least monosubstituted lactams are used, the nitrogen atom and/or the ring carbon atoms thereof may bear one, two, or more substituents selected independently of one another from the group consisting of C₁- to C₁₀-alkyl, C₅- to C₆-cycloalkyl, and C₅- to C₁₀-aryl.

Suitable C₁- to C₁₀-alkyl substituents are, for example, methyl, ethyl, propyl, isopropyl, n-butyl, sec-butyl, and tert-butyl. A suitable C₅- to C₆-cycloalkyl substituent is for example cyclohexyl. Preferred C₅- to C₁₀-aryl substituents are phenyl or anthranyl.

It is preferable to employ unsubstituted lactams, γ-lactam (γ-butyrolactam), δ-lactam (δ-valerolactam) and ε-lactam (ε-caprolactam) being preferred. Particular preference is given to δ-lactam (δ-valerolactam) and ε-lactam (ε-caprolactam), ε-caprolactam being especially preferred.

### Monomer Mixture (M)

According to the invention the component B′) is a monomer mixture (M). The monomer mixture (M) comprises the components B1′), at least one C₃₂-C₄₀-dimer acid, and B2′), at least one C₄-C₁₂-diamine.

In the context of the present invention a monomer mixture (M) is to be understood as meaning a mixture of two or more monomers, wherein at least components B1′) and B2′) are present in the monomer mixture (M).

In the context of the present invention the terms “component B1′)” and “at least one C₃₂-C₄₀-dimer acid” are used synonymously and therefore have the same meaning. The same applies for the terms “component B2′)” and “at least one C₄-C₁₂-diamine”. These terms are likewise used synonymously in the context of the present invention and therefore have the same meaning.

The monomer mixture (M) comprises, for example, in the range from 45 to 55 mol % of the component B1′) and in the range from 45 to 55 mol % of the component B2′) in each case based on the sum of the mole percentages of the components B1′) and B2′), preferably based on the total amount of substance of the monomer mixture (M).

It is preferable when the component B′) comprises in the range from 47 to 53 mol % of component B1′) and in the range from 47 to 53 mol % of component B2′) in each case based on the sum of the mole percentages of the components B1′) and B2′), preferably based on the total amount of substance of the component B′).

It is particularly preferable when the component B′) comprises in the range from 49 to 51 mol % of the component B1′) and in the range from 49 to 51 mol % of the component B2′) in each case based on the sum total of the mole percentages of the components B1′) and B2′), preferably based on the total amount of substance of the component B′).

The mole percentages of the components B1′) and B2′) present in the component B′) typically sum to 100 mol %.

The component B′) may additionally comprise a component B3′), at least one C₄-C₂₀-diacid.

In the context of the present invention, the terms “component B3′)” and “at least one C₄-C₂₀-diacid” are used synonymously and therefore have the same meaning.

When the component B′) additionally comprises the component B3′) it is preferable when component B′) comprises in the range from 25 to 54.9 mol % of the component B1′), in the range from 45 to 55 mol % of the component B2′) and in the range from 0.1 to 25 mol % of the component B3′) in each case based on the total amount of substance of the component B′).

It is particularly preferable when the component B′) then comprises in the range from 13 to 52.9 mol % of the component B1′), in the range from 47 to 53 mol % of the component B2′) and in the range from 0.1 to 13 mol % of the component B3′) in each case based on the total amount of substance of the component B′).

It is most preferable when the component B′) then comprises in the range from 7 to 50.9 mol % of the component B1′), in the range from 49 to 51 mol % of the component B2′) and in the range from 0.1 to 7 mol % of the component B3′) in each case based on the total amount of substance of the component B′).

When component B′) additionally comprises the component B3′) the mole percentages of the components B1′), B2′) and B3′) typically sum to 100 mol %.

The monomer mixture (M) may further comprise water.

The components B1′) and B2′) and optionally B3′) of the component B′) can react with one another to obtain amides. This reaction is known per se to those skilled in the art. The component B′) may therefore comprise components B1′), B2′) and optionally B3′) in fully reacted form, in partially reacted form or in unreacted form. It is preferable when the component B′) comprises the components B1′), B2′) and optionally B3′) in unreacted form.

In the context of the present invention “in unreacted form” is thus to be understood as meaning that the component B1′) is present as the at least one C₃₂-C₄₀-dimer acid and the component B2′) is present as the at least one C₄-C₁₂-diamine and optionally the component B3′) is present as the at least one C₄-C₂₀-diacid.

If the components B1′) and B2′) and optionally B3′) have at least partly reacted the components B1′) and B2′) and any B3′) are thus at least partially in amide form.

### Component B1′)

According to the invention the component B1′) is at least one C₃₂-C₄₀-dimer acid.

In the context of the present invention “at least one C₃₂-C₄₀-dimer acid” is to be understood as meaning either precisely one C₃₂-C₄₀-dimer acid or a mixture of two or more C₃₂-C₄₀-dimer acids.

Dimer acids are also referred to as dimer fatty acids. C₃₂-C₄₀-dimer acids are known per se to those skilled in the art and are typically produced by dimerization of unsaturated fatty acids. This dimerization may be catalyzed by argillaceous earths for example.

Suitable unsaturated fatty acids for producing the at least one C₃₂-C₄₀-dimer acid are known to those skilled in the art and are for example unsaturated C₁₆-fatty acids, unsaturated C₁₈-fatty acids and unsaturated C₂₀-fatty acids.

It is therefore preferable when the component B1′) is produced from unsaturated fatty acids selected from the group consisting of unsaturated C₁₆-fatty acids, unsaturated C₁₈-fatty acids and unsaturated C₂₀-fatty acids, wherein the unsaturated C₁₈-fatty acids are particularly preferred.

A suitable unsaturated C₁₆-fatty acid is palmitoleic acid ((9Z)-hexadeca-9-enoic acid) for example.

Suitable unsaturated C₁₈-fatty acids are for example selected from the group consisting of petroselic acid ((6Z)-octadeca-6-enoic acid), oleic acid ((9Z)-octadeca-9-enoic acid), elaidic acid ((9E)-octadeca-9-enoic acid), vaccenic acid ((11E)-octadeca-11-enoic acid), linoleic acid ((9Z,12Z)-octadeca-9,12-dienoic acid), α-linolenic acid ((9Z,12Z,15Z)-octadeca-9,12,15-trienoic acid), γ-linolenic acid ((6Z,9Z,12Z)-octadeca-6,9,12-trienoic acid), calendulic acid ((8E,10E,12Z)-octadeca-8,10,12-trienoic acid), punicic acid ((9Z,11E,13Z)-octadeca-9,11,13-trienoic acid), α-eleostearic acid ((9Z,11E,13E)-octadeca-9,11,13-trienoic acid) and β-eleostearic acid ((9E,11E,13E)-octadeca-9,11,13-trienoic acid). Particular preference is given to unsaturated C₁₈-fatty acids selected from the group consisting of petroselic acid ((6Z)-octadeca-6-enoic acid), oleic acid ((9Z)-octadeca-9-enoic acid), elaidic acid ((9E)-octadeca-9-enoic acid), vaccenic acid ((11E)-octadeca-11-enoic acid), linoleic acid ((9Z,12Z)-octadeca-9,12-dienoic acid).

Suitable unsaturated C₂₀-fatty acids are for example selected from the group consisting of gadoleic acid ((9Z)-eicosa-9-enoic acid), ecosenoic acid ((11Z)-eicosa-11-enoic acid), arachidonic acid ((5Z,8Z,11Z,14Z)-eicosa-5,8,11,14-tetraenoic acid) and timnodonic acid ((5Z,8Z,11Z,14Z,17Z)-eicosa-5,8,11,14,17-pentaenoic acid).

The component B1′) is especially preferably at least one C₃₆-dimer acid.

The at least one C₃₆-dimer acid is preferably produced from unsaturated C₁₈-fatty acids. It is particularly preferable when the C₃₆-dimer acid is produced from C₁₈-fatty acids selected from the group consisting of petroselic acid ((6Z)-octadeca-6-enoic acid), oleic acid ((9Z)-octadeca-9-enoic acid), elaidic acid ((9E)-octadeca-9-enoic acid), vaccenic acid ((11E)-octadeca-11-enoic acid) and linoleic acid ((9Z,12Z)-octadeca-9,12-dienoic acid).

Production of the component B1′) from unsaturated fatty acids may also form trimer acids and residues of unconverted unsaturated fatty acid may also remain.

The formation of trimer acids is known to those skilled in the art.

According to the invention the component B1′) preferably comprises not more than 0.5% by weight of unreacted unsaturated fatty acid and not more than 0.5% by weight of trimer acid, particularly preferably not more than 0.2% by weight of unreacted unsaturated fatty acid and not more than 0.2% by weight of trimer acid, in each case based on the total weight of component B1′).

Dimer acids (also known as dimerized fatty acids or dimer fatty acids) are thus to be understood as meaning generally, and especially in the context of the present invention, mixtures produced by oligomerization of unsaturated fatty acids. They are producible for example by catalytic dimerization of plant-derived unsaturated fatty acids, wherein the starting materials employed are in particular unsaturated C₁₆- to C₂₀-fatty acids. The bonding proceeds primarily by the Diels-Alder mechanism, and results, depending on the number and position of the double bonds in the fatty acids used to produce the dimer acids, in mixtures of primarily dimeric products having cycloaliphatic, linear aliphatic, branched aliphatic, and also C₆-aromatic hydrocarbon groups between the carboxyl groups. Depending on the mechanism and/or any subsequent hydrogenation, the aliphatic radicals may be saturated or unsaturated and the proportion of aromatic groups may also vary. The radicals between the carboxylic acid groups then comprise 32 to 40 carbon atoms for example. Production preferably employs fatty acids having 18 carbon atoms so that the dimeric product thus has 36 carbon atoms. The radicals which join the carboxyl groups of the dimer fatty acids preferably comprise no unsaturated bonds and no aromatic hydrocarbon radicals.

In the context of the present invention production thus preferably employs C₁₈-fatty acids. It is particularly preferable to employ linolenic, linoleic and/or oleic acid.

Depending on reaction management the above described oligomerization affords mixtures which comprise primarily dimeric, but also trimeric, molecules and also monomeric molecules and other by-products. Purification by distillation is customary. Commercial dimer acids generally comprise at least 80% by weight of dimeric molecules, up to 19% by weight of trimeric molecules, and at most 1% by weight of monomeric molecules and of other by-products.

It is preferable to use dimer acids that consist to an extent of at least 90% by weight, preferably to an extent of at least 95% by weight, very particularly preferably to an extent of at least 98% by weight, of dimeric fatty acid molecules.

The proportions of monomeric, dimeric, and trimeric molecules and of other by-products in the dimer acids may be determined by gas chromatography (GC), for example. The dimer acids are converted to the corresponding methyl esters by the boron trifluoride method (cf. DIN EN ISO 5509) before GC analysis and then analyzed by GC.

In the context of the present invention, it is thus a fundamental feature of “dimer acids” that production thereof comprises oligomerization of unsaturated fatty acids. This oligomerization forms predominantly, i.e. preferably to an extent of at least 80% by weight, particularly preferably at least 90% by weight, very particularly preferably at least 95% by weight and in particular at least 98% by weight, dimeric products. The fact that the oligomerization thus forms predominantly dimeric products comprising precisely two fatty acid molecules justifies this designation which is in any case commonplace. An alternative expression for the relevant term “dimer acids” is thus “mixture comprising dimerized fatty acids”.

The dimer acids to be used are obtainable as commercial products. Examples include Radiacid 0970, Radiacid 0971, Radiacid 0972, Radiacid 0975, Radiacid 0976, and Radiacid 0977 from Oleon, Pripol 1006, Pripol 1009, Pripol 1012, and Pripol 1013 from Croda, Empol 1008, Empol 1012, Empol 1061, and Empol 1062 from BASF SE, and Unidyme 10 and Unidyme TI from Arizona Chemical.

The component B1′) has an acid number in the range from 190 to 200 mg KOH/g for example.

### Component B2′)

According to the invention the component B2′) is at least one C₄-C₁₂-diamine.

In the context of the present invention “at least one C₄-C₁₂-diamine” is to be understood as meaning either precisely one C₄-C₁₂-diamine or a mixture of two or more C₄-C₁₂-diamines.

In the context of the present compound, “C₄-C₁₂-diamine” is to be understood as meaning aliphatic and/or aromatic compounds having four to twelve carbon atoms and two amino groups (—NH₂ groups). The aliphatic and/or aromatic compounds may be unsubstituted or additionally at least monosubstituted. If the aliphatic and/or aromatic compounds are additionally at least monosubstituted, they may bear one, two or more substituents that do not take part in the polymerization of the components A′) and B′). Such substituents are for example alkyl or cycloalkyl substituents. These are known per se to those skilled in the art. The at least one C₄-C₁₂-diamine is preferably unsubstituted.

Suitable components B2′) are for example selected from the group consisting of 1,4-diaminobutane (butane-1,4-diamine; tetramethylenediamine; putrescine), 1,5-diaminopentane (pentamethylenediamine; pentane-1,5-diamine; cadaverine), 1,6-diaminohexane (hexamethylenediamine; hexane-1,6-diamine), 1,7-diaminoheptane, 1,8-diaminooctane, 1,9-diaminononane, 1,10-diaminodecane (decamethylenediamine), 1,11-diaminoundecane (undecamethylenediamine) and 1,12-diaminododecane (dodecamethylenediamine).

It is preferable when the component B2′) is selected from the group consisting of tetramethylenediamine, pentamethylenediamine, hexamethylenediamine, decamethylenediamine and dodecamethylenediamine.

### Component B3′)

According to the invention the component B3′) optionally present in the component B′) is at least one C₄-C₂₀-diacid.

In the context of the present invention, “at least one C₄-C₂₀-diacid” is to be understood as meaning either precisely one C₄-C₂₀-diacid or a mixture of two or more C₄-C₂₀-diacids.

In the context of the present invention “C₄-C₂₀-diacid” is to be understood as meaning aliphatic and/or aromatic compounds having two to eighteen carbon atoms and two carboxyl groups (—COOH groups). The aliphatic and/or aromatic compounds may be unsubstituted or additionally at least monosubstituted. If the aliphatic and/or aromatic compounds are additionally at least monosubstituted, they may bear one, two or more substituents that do not take part in the polymerization of components A′) and B′). Such substituents are for example alkyl or cycloalkyl substituents. These are known to those skilled in the art. Preferably, the at least one C₄-C₂₀-diacid is unsubstituted.

Suitable components B3′) are for example selected from the group consisting of butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, tridecanedioic acid, tetradecanedioic acid and hexadecanedioic acid.

It is preferable when the component B3′) is selected from the group consisting of pentanedioic acid (glutaric acid), hexanedioic acid (adipic acid), decanedioic acid (sebacic acid) and dodecanedioic acid.

Most preferably, component A) is selected from the group consisting of PA 6, PA 66, PA 46, PA 6/66, PA 66/6, PA 6/6.36, PA610, PA 6T/6, PA 6T/6I, PA 6T/6I/66, PA 9T and PA 6T/66, more preferably from PA 6, PA 6.6, PA 66/6, PA 6/6.6 and mixtures thereof, and most preferably PA 6 and PA 66 and mixtures thereof.

### Component B)

As component B), the thermoplastic moulding composition contains 0.01 to 0.5% by weight, preferably 0.06 to 0.45% by weight, more preferably 0.1 to 0.4% by weight, based on the total amount of components A), B), C), D), optionally E), optionally F), optionally G), optionally H) and optionally I), of at least one of sodium hypophosphite or a hydrate of sodium hypophosphite.

The sodium hypophosphite and the hydrate of sodium hypophosphite employed as component B) according to the present invention are commercially available. Most preferred is sodium hypophosphite monohydrate (CAS: 10039-56-2).

### Component C)

As component C), the thermoplastic moulding composition contains from 0.01 to 5% by weight, preferably 0.05 to 3% by weight, more preferably 0.1 to 2% by weight, based on the total amount of components A), B), C), D), optionally E), optionally F), optionally G), optionally H) and optionally I), of a colourant comprising at least one not covalently bonded sulfur atom or two or more colourants comprising at least one sulfur containing colourant comprising at least one not covalently bonded sulfur atom, preferably an orange colourant comprising at least one not covalently bonded sulfur atom or two or more colourants resulting in the colour orange comprising at least one sulfur containing colourant comprising at least one not covalently bonded sulfur atom, with particular preference for shades corresponding in the RAL colour system to the colour numbers RAL 2001, RAL 2003, RAL 2004, RAL 2007, RAL 2008, RAL 2009, RAL 2010 and RAL 2011, and very particular preference for the shades corresponding in the RAL colour system to the colour numbers RAL 2003, RAL 2008 and RAL 2011.

In the meaning of the present invention, a sulfur containing colourant comprising at least one not covalently bonded sulfur atom usually comprises at least one sulfur atom which is ionically bonded. Component C) is therefore able to release hydrogen sulfide in the presence of acidic compounds.

A person skilled in the art knows the types of bonds mentioned above (covalent bond and ionic bond).

An ionic bond is a result of the attraction between ions. Ions are formed when an atom loses or gains an electron. These types of bonds are commonly formed between a metal and a non-metal.

In the case of a covalent bond, an atom shares one or more pairs of electrons with another atom and forms a bond. Such a type of bonding is common between two non-metals. The covalent bond may be a non-polar covalent bond or a polar covalent bond. In the case of a non-polar covalent bond the electrons are equally shared between the two atoms. In polar covalent bonds, the electrons are unequally distributed between the atoms.

Suitable colourants are pigments or dyes, for example inorganic pigments or organic pigments or dyes.

Suitable inorganic pigments and organic colourants are mentioned below, with the proviso that at least one sulfur containing colourant comprising at least one not covalently bonded sulfur atom is present in the inventive thermoplastic moulding composition.

Suitable inorganic pigments are for examples ultramarine blue, cobalt aluminate e.g. Heucodur Blue 552 of Heubach GmbH, bismuth vanadate, iron oxide, titanium dioxide, zinc sulfide, zinc oxide, cerium sulfide, especially cerium(III) sulfide [CAS 12014-93-6], cerium sulfide/lanthanum sulfide, especially cerium(III) sulfide/lanthanum(III) sulfide [CAS 12014-93-6; CAS 12031-49-1], tin titanium zinc oxide [CAS 923954-49-8].

Suitable organic colourants are for example phthalocyanines, benzimidazoles, Ie.g. Keyplast FL OR YF of Milliken and Ni-2-hydroxy-naphthyl-benzimidazole (Pigment Orange 86, [CAS 42844-93-9]) e.g. PV Fast Orange 6RL of Heubach GmbH, pyridinium-azo-benzimidazole [CAS 72102-84-2] or the condensation product of 5,6-diamino-1,3-dihydro-2H-benzimidazole-2-one with benzo[de] isochroman-1,3-dione, pigment yellow 192 [CAS 56279-27-7], perylenes, anthraquinones, especially the condensation product of 1,8-dichloroanthracene-9,10-dione and benzene thiol (solvent yellow 163, [CAS 13676-91-0]), 10,10′-oxybis-12H-phthaloperin-12-one (Solvent Orange 111, [CAS 203576-97-0]), e.g. Macrolex Orange HT of Lanxess Deutschland GmbH, Cologne, 14H-anthra [2,1,9-m,n,a]thioxanthen-14-one, e.g. Hostasol Red GG of Heubach GmbH (Solvent Orange 63, [CAS 16294-75-0]), 2-Octadecyl-1H-thioxantheno [2,1,9-def] isoquinoline-1,3 (2H)-dione, e.g. Hostasol Yellow 3G of Heubach GmbH (Solvent Yellow 98, [CAS 12671-74-8]) or 12H-phthaloperin-12-one (solvent orange 60, [CAS 6925-69-5]).

Since polyamide moulding compositions employed in high-voltage components are of particular interest according to the present invention and it is suggested according to ISO 6469-3 that such high-voltage components should be coloured orange, orange colourants comprising at least one not covalently bonded sulfur atom or mixtures of two or more colourants, comprising at least one sulfur containing colourant comprising at least one not covalently bonded sulfur atom resulting in the colour orange are preferred in the thermoplastic polyamide moulding compositions according to the present invention.

The thermoplastic moulding composition according to the present invention therefore preferably comprises an orange colourant comprising at least one not covalently bonded sulfur atom or two or more colourants resulting in the colour orange comprising at least one sulfur containing colourant comprising at least one not covalently bonded sulfur atom, with particular preference for shades corresponding in the RAL colour system to the colour numbers RAL 2001, RAL 2003, RAL 2004, RAL 2007, RAL 2008, RAL 2009, RAL 2010 and RAL 2011, and very particular preference for the shades corresponding in the RAL colour system to the colour numbers RAL 2003, RAL 2008 and RAL 2011. More preferably, component C) is an orange colourant comprising at least one not covalently bonded sulfur atom or two or more colourants resulting in the colour orange comprising at least one sulfur containing colourant comprising at least one not covalently bonded sulfur atom with a shade corresponding in the RAL colour system to the colour number RAL 2003.

Preferred colourants C) are therefore colourants comprising at least one not covalently bonded sulfur atom or two or more colourants comprising at least one sulfur containing colourant comprising at least one not covalently bonded sulfur atom resulting in RAL 2003, RAL 2008 and RAL 2011, preferably cerium comprising sulfides, especially cerium(III) sulfide (Ce₂S₃) [CAS 12014-93-6], known as C.I.® Pigment Orange 75), cerium(III) sulfide/lanthanum (III) sulfide (Ce₂S₃/La₂S₃) ([CAS 12014-93-6; CAS 12031-49-1], e.g. C.I.® Pigment Orange 78), zinc sulfide, and tin titanium zinc oxide [CAS 923954-49-8] e.g. Sicopal Orange K2430 of BASF SE, wherein the tin titanium zinc oxide is employed together with at least one sulfur containing colourant comprising at least one not covalently bonded sulfur atom.

More preferred colourants C) are cerium comprising sulfides, especially cerium(III)sulfide (Ce2S3) [CAS-Nr. 12014-93-6; known as C.I.Pigment Orange 75], cerium(III) sulfide/lanthanum(III)sulfide (Ce2S3/La2S3) [CAS-Nr. 12014-93-6; CAS-Nr. 12031-49-1; known as C.I. Pigment Orange 78, or zinc sulfide. Most preferred are cerium(III)sulfide/lanthanum(III)sulfide (C.I. Pigment Orange 78) and zinc sulfide.

C.I.® Pigment Orange 75 and C.I.® Pigment Orange 78 are commercially available for example from Chemikos, Dr. Oliver Schmitt, Karlsruhe, Germany, or as Neolor® Orange H and Neolor® light Orange H of Baotou Hongbo Te Technology Co Ltd.

C.I. means colour index and is a dual classification system [https://www.chemikos.de/cersulfid-orange-pigmente]. The prime descriptor is the colour index generic name (often abbreviated to CIGN). The other descriptor is the colour index constitution number (often abbreviated to CICN) which is chemical structure related. Above, the CIGN is used in the description of suitable colourants.

Said CIGN describes a commercial product by its recognised usage class, its hue and a serial number (which simply reflects the chronological order in which related colourant types have been registered with the colour index).

Component C) is generally employed directly as a powder or in form of a paste, a master batch, a compact or a concentrate comprising component C). Preferably, component C) is employed in form of a powder.

### Component D)

As component D), the thermoplastic moulding composition contains from 0.01 to 2% by weight, preferably 0.02 to 1.8% by weight, more preferably 0.03 to 1.5% by weight, based on the total amount of components A), B), C), D), optionally E), optionally F), optionally G), optionally H) and optionally I), of at least one acid scavenger.

“Acid scavenger” in the meaning of the present invention refers to a compound or a composition which can consume, deplete or react with acidic components usually generated during compounding, which inhibit the generation of hydrogen sulfide in the environment of the inventive thermoplastic molding compositions.

Acid scavengers suitable for use in the present invention include:
At least one organic or inorganic base, preferably at least one inorganic base, more preferably selected from the group consisting of oxides, hydroxides, carbonates, silicates, borates, stannates, mixed oxides-hydroxides, oxides-hydroxides-carbonates, hydroxides-silicates or hydroxides-borates of at least one element selected from the group consisting of alkali metals, alkaline earth metals, elements of the boron group (group 13 in the periodic table IUPAC version), zinc and tin; salts of fatty acids; hydrotalcites; ricinoleates and mixtures thereof.

Examples for acid scavengers in accordance with the present invention are:
Magnesium oxide, calcium oxide, aluminum oxide, zinc oxide, manganese oxide, tin oxide, aluminum hydroxide, boehmite, hydrocalumite, magnesium hydroxide, calcium hydroxide, zinc hydroxide, tin oxide hydrate, manganese hydroxide, zinc borate, basic zinc silicates, zinc stannate, calcium stearate, zinc stearate, calcium lactate, calcium stearoyl lactylate, zinc ricinoleate, natural and synthetic hydrotalcites like magnesium aluminum hydrotalcite, and mixtures thereof. Preferred acid scavengers for use in the present invention are magnesium aluminum hydrotalcite, e.g. known as Hycite® 713 from BASF SE, zinc stannate and lanthanum carbonate.

### Component E)

As component E), the thermoplastic moulding composition contains from 0 to 20% by weight, preferably from 0.01 to 18% by weight, more preferably from 0.1 to 17% by weight, most preferably from 1 to 16% by weight, based on the total amount of components A), B), C), D), optionally E), optionally F), optionally G), optionally H) and optionally I), of at least one polyamide 6I/6T.

Preferably, component E) comprises units derived from hexamethylene diamine, from terephthalic acid and from isophthalic acid. In other words, component E) is a copolymer prepared from hexamethylene diamine, terephthalic acid and isophthalic acid.

More preferably, component E) consists of units derived from hexamethylene diamine, from terephthalic acid and from isophthalic acid. It is preferably a random copolymer. The polyamide 6I/6T used as component E) comprises isophthalic acid units (6I units) and terephthalic acid units (6T units). Preferably, the molar ratio of 6I units to 6T units is in the range from 1:1 to 3:1, more preferably in the range of from 1.5:1 to 2.5:1 and most preferably in the range of from 1.8:1 to 2.3:1.

The polyamide 6I/6T is an amorphous copolyamide. It is known in the art that in the case that polyamide 6I/6T is mainly based on PA6T, the resulting polyamide will be semi-crystalline (often described as PA6T/6I). On the contrary, when polyamide 6I/6T is mainly based on PA6I (i.e. more than 55% of isophthalic acid; often described as PA6I/6T), the resulting polymer will be amorphous (see Kohan, Melvin I.: Nylon Plastics Handbook, Carl Hanser Verlag, Munich Vienna New York, 1995, p, page 373; Stephanie Djukic et al., Heliyon 6 (2020) e03857; https://en.wikipedia.org/wiki/Polyphthalamide).

“Amorphous” in the context of the present invention means that the pure polyamide 6I/6T does not have any melting point in the differential scanning calorimetry (DSC) measured according to ISO 11357-1:2017:02.

The polyamide 6I/6T has a glass transition temperature (T_{G}) which is typically in the range from 100 to 150° C., preferably 115 to 135° C. and more preferably 120 to 130° C. The glass transition temperature (T_{G}) of polyamide 6I/6T is determined by means of differential scanning calorimetry. For determination, in accordance with the invention, a first heating run (H1), then a cooling run (C) and subsequently a second heating run (H2) is measured on a sample of polyamide 6I/6T (starting weight about 8.5 g). The heating rate in the first heating run (H1) and in the second heating run (H2) is 20 K/min; the cooling rate in the cooling run (C) is likewise 20 K/min. In the region of the glass transition of polyamide 6I/6T, a step is obtained in the second heating run (H2) in the DSC diagram. The glass transition temperature (T_{G}) of the polyamide 6I/6T corresponds to the temperature at half the step height in the DSC diagram.

The MVR (275° C./5 kg) (melt volume flowrate) is preferably in the range from 50 ml/10 min to 150 ml/10 min, more preferably in the range from 95 ml/10 min to 105 ml/10 min (the melt volume flowrate (MVR) is determined according to EN ISO 1133-1:2011, procedure A).

The polyamide 6I/6T employed as component E) according to the present invention has an amino end group concentration (AEG) which is preferably in the range from 35 to 45 mmol/kg and especially preferably in the range from 35 to 42 mmol/kg.

For determination of the amino end group concentration (AEG) 1 g of polyamide 6I/6T is dissolved in 30 ml of a phenol/methanol mixture (volume ratio of phenol:methanol 75:25) and then subjected to potentiometric titration with 0.2 N hydrochloric acid in water.

The polyamide 6I/6T employed as component E) according to the present invention generally has a carboxyl end group concentration (CEG) which is preferably in the range from 60 to 300 mmol/kg and more preferably in the range from 80 to 200 mmol/kg.

The carboxylic end group concentration (CEG) was determined by NMR in HFIP-d₂

Suitable commercially available polyamides 6I/6T as component E) according to the present invention are Zytel® HTN301 (former Selar® PA3426R) of DuPont with a molar ratio of 6I:6T of 2.2:1, Grivory G21, EMS, with a molar ratio of 6I:6T of 2.1:1 and Grivory G16, EMS, with a molar ratio of 6I:6T of 1.9:1.

### Component F)

Also important for high-voltage components, especially high-voltage components in electromobility, is the possibility of identification in order to identify these with additional information such as serial numbers, manufacturer features, installation information or safety-relevant information. A suitable means of identifying polymer-based components is laser inscription (see https://de.wikipedia.org/wiki/Laserbeschriftung), preference being given to using a solid-state laser with Nd:YAG or Nd:YV04 crystal of wavelength 1064 nm, 532 nm or 355 nm, particular preference being given to using lasers of wavelength 1064 nm. As component F), the thermoplastic moulding composition contains from 0 to 5% by weight, preferably 0 to 3% by weight, more preferably 0.1 to 2% by weight, based on the total amount of components A), B), C), D), optionally E), optionally F), optionally G), optionally H) and optionally l), of a laser inscription additive, preferably a pigment system comprising a metal oxide or a mixture of two or more metal oxides, more preferably antimony trioxide, titanium dioxide, glimmer, tin oxide, ferrous oxide, zinc oxide, aluminum oxide, bismuth trioxide, or mixtures thereof, as component F). Examples for mixed oxides are inorganic mixed oxides containing antimony trioxide, titanium dioxide, tin oxide, ferrous oxide, and/or zinc oxide, like antimony tin oxide or mixed oxides of titanium dioxide, tin oxide, and/or zinc oxide.

In one embodiment of the present invention the laser inscription additive is free of antimony.

Glimmer is in the meaning of the present invention a group of minerals generally comprising the following composition:

DG₂₋₃[T₄O₁₀]X₂
wherein
D represents ammonium (NH₄⁺), barium, caesium, calcium, potassium, sodium, rubidium
G represents aluminum, chrome, iron (Fe²⁺, Fe³⁺), lithium, magnesium, titanium, vanadium, zinc
T=aluminum, beryllium, boron, iron (Fe³⁺), silicium
X=anions: Cl⁻, O²⁻, OH⁻, F⁻, S²⁻

The oxides mentioned above may be surface modified for example by a coating comprising antimony, ferrous oxide, tin oxide and/or zinc oxide, e.g. TiO₂ particles coated on the surface with an antimony doped tin dioxide layer (Sn,Sb)O₂ or calcined antimony/tin mixed oxides in which the antimomy concentration is at the surface greater than in the particles as a whole. See for example DE102015009854 A and EP1377522 A2.

Other suitable laser inscription additives are for example tin orthophosphate, barium titanate, copper hydroxyphosphate, copper orthophosphate, potassium copper diphosphate, copper hydroxide, and anthraquinone.

The laser inscription additives mentioned above are commercially available or obtainable by methods known by a person skilled in the art.

The laser inscription additive may be used directly as powder, or else in the form of a paste or a masterbatch, compact or concentrate. The person skilled in the art will understand the term “masterbatch” to mean plastics additives in the form of granules, here with a content of laser inscription additive higher than in the final application.

### Component G)

As component G), the thermoplastic moulding composition contains 0 to 60 wt %, preferably 0 to 55 wt %, more preferably 0 to 50 wt %, based on the total amount of components A), B), C), D), optionally E), optionally F), optionally G), optionally H) and optionally I), of at least one fibrous and/or particulate filler.

Preferably, component G) comprises glass fibres and is present in an amount of from 5 to 60 wt %, more preferably 10 to 55 wt %, most preferably 15 to 50 wt %, based on the total amount of components A), B), C), D), optionally E), optionally F), optionally G), optionally H) and optionally I).

If component G) is present, the maximum amount of component A) is decreased by the minimum amount of component G), so that the total amount of components A) to I) is still 100 wt %.

It is also possible to use mixtures of two or more different fibrous and/or particulate fillers.

Fibrous or particulate fillers G) that may be mentioned are at least one fibrous and/or particulate filler from the group of carbon fibres, glass beads, e.g. solid or hollow glass beads, or glass fibres, or ground glass, amorphous quartz glass, aluminum borosilicate glass having an alkali content of 1% (E glass), amorphous silica, quartz flour, alkaline earth metal silicate, especially calcium silicate, calcium metasilicate, magnesium carbonate, kaolin, calcined kaolin, chalk, kyanite, powdered or milled quartz, mica, phlogopite, feldspar, barium sulfate, wollastonite, montmorillonite, pseudoboehmite of formula AlO(OH), magnesium carbonate, talc, aramid fibres, potassium titanate fibres, barium carbonate, alkaline earth metal oxide, metallic fibres, ceramic fibres, titanium dioxide, aluminum oxide, plaster, zirconium oxide, antimony oxide, clay, silica-alumina, sericite, diatomite, silica stone, carbon black, glassy hollow microspheres (Shirasu® balloon), red oxide, zinc oxide, and mixtures thereof.

Other fillers which may be mentioned are lamellar or acicular fillers, the amounts of these preferably being from 0.1 to 10%-if present. Materials preferred for this purpose are boehmite, bentonite, montmorillonite, vermiculite, hectorite, and Laponite®. The lamellar nanofillers are organically modified by prior art methods, to give them good compatibility with the organic binder. Addition of the lamellar or acicular fillers to the inventive thermoplastic moulding compositions gives a further increase in mechanical strength.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may optionally have been pretreated with the abovementioned silane compounds, but the pretreatment is not essential.

Preferred fibrous or particulate fillers G) are glass fibres. The glass fibres are generally chopped fibres, also called short fibres, having a length in the range from 0.1 to 1 mm, long fibres having a length in the range from 1 to 50 mm, and continuous fibres having a length l>50 mm. Continuous fibres are used in the form of rovings or fabric in fibre-reinforced plastics.

Also available are ground glass fibres, the length of which after grinding is typically in the range from 70 to 200 μm.

Particular preference being given to glass fibres in the form of rovings or in the forms of chopped glass as described above.

More preferred glass fibres to be used as component G) are chopped long glass fibres having an average starting length to be determined by laser diffraction-particle size analysis (laser granulometry/laser diffractometry) according to ISO 13320 in the range from 1 to 50 mm, more preferably in the range from 1 to 10 mm, most preferably in the range from 2 to 7 mm. Most preferred glass fibres for use as component G) have an average fibre diameter to be determined by laser diffractometry according to ISO 13320 in the range from 7 to 18 μm, more preferably in the range from 9 to 15 μm.

In a preferred embodiment, the glass fibres for use with preference as component G) are modified with a suitable size system or an adhesion promoter/adhesion promoter system. Preference is given to using a size system or an adhesion promoter based on silane, to improve compatibility with the thermoplastic.

Suitable silane compounds have the general formula:

(X—(CH₂)ₙ)ₖ—Si—(O—CₘH₂ₘ₊₁)₄₋ₖ

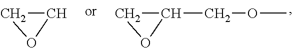

X is —NH2, HO—, carboxyl,
n is an integer from 2 to 10, preferably 3 to 4,
m is an integer number from 1 to 5, preferably 1 to 2, and
k is an integer from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group or a carboxyl group as substituent X.

For the modification of the glass fibres for use with preference as component G), the adhesion promoter, preferably the silane compounds of formula (II), is used preferably in amounts of 0.01% to 2% by weight, more preferably in amounts of 0.025% to 1.5% by weight and most preferably in amounts of 0.05% to 1% by weight, based in each case on 100% by weight of component F).

The glass fibres to be used with preference as component G), as a result of the processing to give the thermoplastic moulding composition, may be shorter in the composition than the glass fibres originally used. Thus, the arithmetic average of the glass fibre length after processing, to be determined by high-resolution X-ray computed tomography, is frequently only in the range from 150 μm to 300 μm.

Those skilled in the art distinguish between different types of glass fibres, some of which are listed here by way of example (https://polser.com/en/frp/fibreglass-types):

| | Glass Fibre | | | | | | | | |
|---|---|---|---|---|---|---|---|---|---|
| | A | C | D | E | | ECR | AR | R | S-2 |
| | Type | Type | Type | Type | Advantex | Glass | Type | Type | Type |
| Oxide | wt % | wt % | wt % | wt % | wt % | wt % | wt % | wt % | wt % |
| Silicon Dioxides(SiO2) | 63-72 | 64-68 | 72-75 | 52-56 | 59-62 | 54-62 | 55-75 | 56-60 | 64-66 |
| Alumina (Al2O3) | 0-6 | 3-5 | 0-1 | 12-16 | 12-15 | 9-15 | 0-5 | 23-26 | 24-26 |
| Boron Trioxide (B2O3) | 0-6 | 4-6 | 21-24 | 5-10 | <0.2 | — | 0-8 | 0-0.3 | <0.05 |
| Calcium Oxide (CaO) | 6-10 | 11-15 | 0-1 | 16-25 | 20-24 | 17-25 | 1-10 | 8-15 | 0-0.2 |
| Magnesium Oxide (MgO) | 0-4 | 2-4 | — | 0-5 | 1-4 | 0-4 | — | 4-7 | 9.5-10.3 |
| Zinc Oxide (ZnO) | — | — | — | — | — | 2-5 | — | — | — |
| Barium Oxide (BaO) | — | 0-1 | — | — | — | — | — | 0-0.1 | — |
| Lithium Oxide (Li2O) | — | — | — | — | — | — | 0-1.5 | — | — |
| Sodium Oxide + Potassium | 14-16 | 7-10 | 0-4 | 0-2 | — | 0-2 | 11-21 | 0-1 | <0.3 |
| Oxide (Na2O + K2O) | | | | | | | | | |
| Titanium Dioxides (TiO2) | 0-0.6 | — | — | 0-0.8 | — | 0-4 | 0-12 | 0-0.25 | — |
| Zirconium Dioxides (ZrO2) | — | — | — | — | — | — | 1-18 | — | — |
| Iron Oxide (Fe2O3) | 0-0.5 | 0.8 | 0-0.3 | 0-0.4 | — | 0-0.8 | 0-5 | 0-0.5 | 0-0.1 |
| Flour (F2) | 0-0.4 | — | — | 0-1 | — | — | — | 0-0.1 | — |

Particular preference being given to glass fibres in the form of E glass. These can be used as rovings or in the commercially available forms of chopped glass, whereby suitable rovings and chopped glass fibres are described above. Said E glass fibres are modified with a suitable size system or an adhesion promoter/adhesion promoter system. Preference is given to using a size system or an adhesion promoter based on silane, to improve compatibility with the thermoplastic. Suitable silane compounds are mentioned above.

It is further possible to use as component G) non-fibrous and non-foamed milled glass having a particle size distribution to be determined by laser diffractometry according to ISO 13320 having a d₉₀ in the range from 5 to 250 μm, preferably in the range from 10 to 150 μm, more preferably in the range from 15 to 80 μm, most preferably in the range from 16 to 25 μm. With regard to the d₉₀ values, their determination and their significance, reference is made to Chemie Ingenieur Technik (72) pp. 273-276, 3/2000, Wiley-VCH Verlags GmbH, Weinheim, 2000, according to which the doo value is that particle size below which 90% of the amount of particles lie (volume distribution).

It is preferable in accordance with the invention when the non-fibrous and non-foamed milled glass has a particulate, non-cylindrical shape and has a length to thickness ratio to be determined by laser diffractometry according to ISO 13320 of less than 5, preferably less than 3, more preferably less than 2. It will be appreciated that the value of zero is impossible. The non-foamed and non-fibrous milled glass is additionally characterized in that it generally does not have the glass geometry typical of fibrous glass with a cylindrical or oval cross section having a length to diameter ratio (L/D ratio) to be determined by laser diffractometry according to ISO 13320 greater than 5.

The non-foamed and non-fibrous milled glass is preferably obtained by grinding glass with a mill, preferably a ball mill, and more preferably with subsequent sifting or sieving. Preferred starting materials for the milling of the non-fibrous and non-foamed milled glass for use as component G) in one embodiment also include glass wastes as generated as unwanted byproduct and/or as off-spec primary product (called offspec material) especially in the production of glass products. These especially include waste glass, recycled glass and broken glass as can be obtained especially in the production of window or bottle glass, and in the production of glass containing fillers and reinforcers, especially in the form of what are called melt cakes. The glass may be coloured, but preference is given to non-coloured glass as the starting material for use as component G).

### Component H)

As component H), the thermoplastic moulding composition contains 0 to 55 wt %, preferably 0 to 35 wt %, more preferably 0 to 25 wt %, based on the total amount of components A), B), C), D), optionally E), optionally F), optionally G), optionally H) and optionally I), of at least one flame retardant additive.

In the case that the thermoplastic moulding composition comprises at least one flame retardant additive, said at least one flame retardant additive is present in an amount of from 1 to 55 wt %, more preferably 2 to 35 wt %, most preferably 3 to 25 wt %, based on the total amount of components A), B), C), D) optionally E), optionally F), optionally G), optionally H) and optionally I).

If component H) is present, the maximum amount of component A) is decreased by the minimum amount of component H), so that the total amount of components A) to I) is still 100 wt %.

It is also possible to use mixtures of two or more flame retardant additives.

Component H) is at least one halogen-free flame retardant and/or at least one halogen-containing flame retardants, preferably selected from at least one member of the group consisting of phosphazenes, aliphatic or aromatic esters of phosphoric acid or polyphosphoric acid, metal phosphinates or phosphinic acid salts other than component B), bromine-containing flame retardants, chlorine-containing flame retardants, flame-retardant melamine compounds, benzoguanidine compounds or the salts thereof, allantoin compounds or the salts thereof, glycolurils or the salts thereof, cyanoguanidines, metal oxides such as antimony trioxide, antimony pentoxide, and/or sodium antimonate, phosphorus, such as red phosphorus, dicarboxylic acids of formula

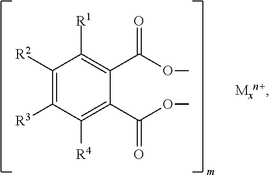

wherein
R¹ to R⁴ independently of one another represent halogen or hydrogen with the proviso that at least one radical R¹ to R⁴ represents halogen,
x=1 to 3, preferably 1, 2
m=1 to 9, preferably 1 to 3, 6, 9, in particular 1 to 3
n=2 to 3
M=alkaline earth metal, Ni, Ce, Fe, In, Ga, Al, Pb, Y, Zn, Hg, functional polymers comprising 1,2-bis[4-(2-hydroxyethoxy)phenyl]ethanone repeating units and poly(2,6-dimethyl-1,4-phenyleneoxide) (PPPO).

As component H), the thermoplastic moulding materials can for example comprise 1.0 to 10.0 wt %, preferably 2.0 to 6.0 wt %, in particular 3.0 to 5.0 wt %, of at least one phosphazene of general formula (IX) or (X) as flame retardant.

The minimum amount of this component H)—if present—is at least 1.0 wt %, preferably 2.0 wt %, in particular 3.0 wt %.

The maximum amount of this component H) is 10.0 wt %, preferably 6.0 wt %, particularly preferably 5.0 wt %.

“Phosphazenes” is to be understood as meaning cyclic phosphazenes of general formula (IX)

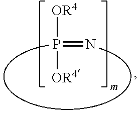

in which m is an integer from 3 to 25 and R⁴ and R^{4′} are identical or different and represent C₁-C₂₀-alkyl-, C₆-C₃₀-aryl-, C₆-C₃₀-arylalkyl- or C₆-C₃₀-alkyl-substituted aryl or linear phosphazenes of general formula (X)

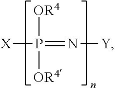

in which n represents 3 to 1000 and X represents —N═P(OPh)₃ or —N═P(O)OPh and Y represents —P(OPh)₄ or —P(O)(OPh)₂.

The production of such phosphazenes is described in EP-A 0 945 478.

Particular preference is given to cyclic phenoxyphosphazenes of formula P₃N₃C₃₆ of formula (XI)

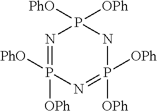

or linear phenoxyphosphazenes according to formula (XII)

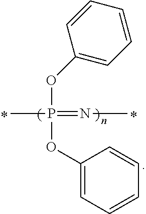

The phenyl radicals may optionally be substituted. Phosphazenes in the context of the present application are described in Mark, J. E., Allcock, H. R., West, R., Inorganic Polymers, Prentice Hall, 1992, pages 61 to 141.

Preferably employed as component H) are cyclic phenoxyphosphazenes having at least three phenoxyphosphazene units. Corresponding phenoxyphosphazenes are described for example in US 2010/0261818 in paragraphs [0051] to [0053]. Reference may in particular be made to formula (I) therein. Corresponding cyclic phenoxyphosphazenes are furthermore described in EP-A-2 100 919, in particular in paragraphs [0034] to [0038] therein. Production may be effected as described in EP-A-2 100 919 in paragraph [0041]. In one embodiment of the invention the phenyl groups in the cyclic phenoxyphosphazene may be substituted by C₁₋₄-alkyl radicals. It is preferable when pure phenyl radicals are concerned.

For further description of the cyclic phosphazenes reference may be made to Römpp Chemie Lexikon, 9th ed., keyword “phosphazenes”. Production is effected for example via cyclophosphazene which is obtainable from PCl₅ and NH₄Cl, wherein the chlorine groups in the cyclophosphazene have been replaced by phenoxy groups by reaction with phenol.

The cyclic phenoxy phosphazene compound may for example be produced as described in Allcock, H. R., Phosphorus-Nitrogen Compounds (Academic Press, 1972), and in Mark, J. E., Allcock, H. R., West, R., Inorganic Polymers (Prentice Hall, 1992).

Component H) is preferably a mixture of cyclic phenoxyphosphazenes having three and four phenoxy phosphazene units. The weight ratio of rings comprising three phenoxyphosphazene units to rings comprising four phenoxyphosphazene units is preferably about 80:20. Larger rings of the phenoxyphosphazene units may likewise be present but in smaller amounts. Suitable cyclic phenoxyphosphazenes are obtainable from Fushimi Pharmaceutical Co., Ltd., under the name Rabitle® FP-100. This is a matt-white/yellowish solid having a melting point of 110° C., a phosphorus content of 13.4% and a nitrogen content of 6.0%. The proportion of rings comprising three phenoxyphosphazene units is at least 80.0 wt %.

The thermoplastic moulding materials can for example comprise 1.0 to 6.0 wt %, preferably 2.5 to 5.5 wt %, in particular 3.0 to 5.0 wt % of at least one aliphatic or aromatic ester of phosphoric acid or polyphosphoric acid as flame retardant, based on the total amount of components A), B), C), D), optionally E), optionally F), optionally G), optionally H) and optionally I).

In this case especially solid, non-migrating phosphate esters having a melting point between 70° C. and 150° C. are preferred. This has the result that the products are easy to meter and exhibit markedly less migration in the moulding material. Particularly preferred examples are the commercially available phosphate esters PX-200 (CAS: 139189-30-3) from Daihachi, or Sol-DP from ICL-IP. Further phosphate esters with appropriate substitution of the phenyl groups are conceivable when this allows the preferred melting range to be achieved. The general structural formula, depending on the substitution pattern in the ortho position or the para position on the aromatic ring, is as follows:

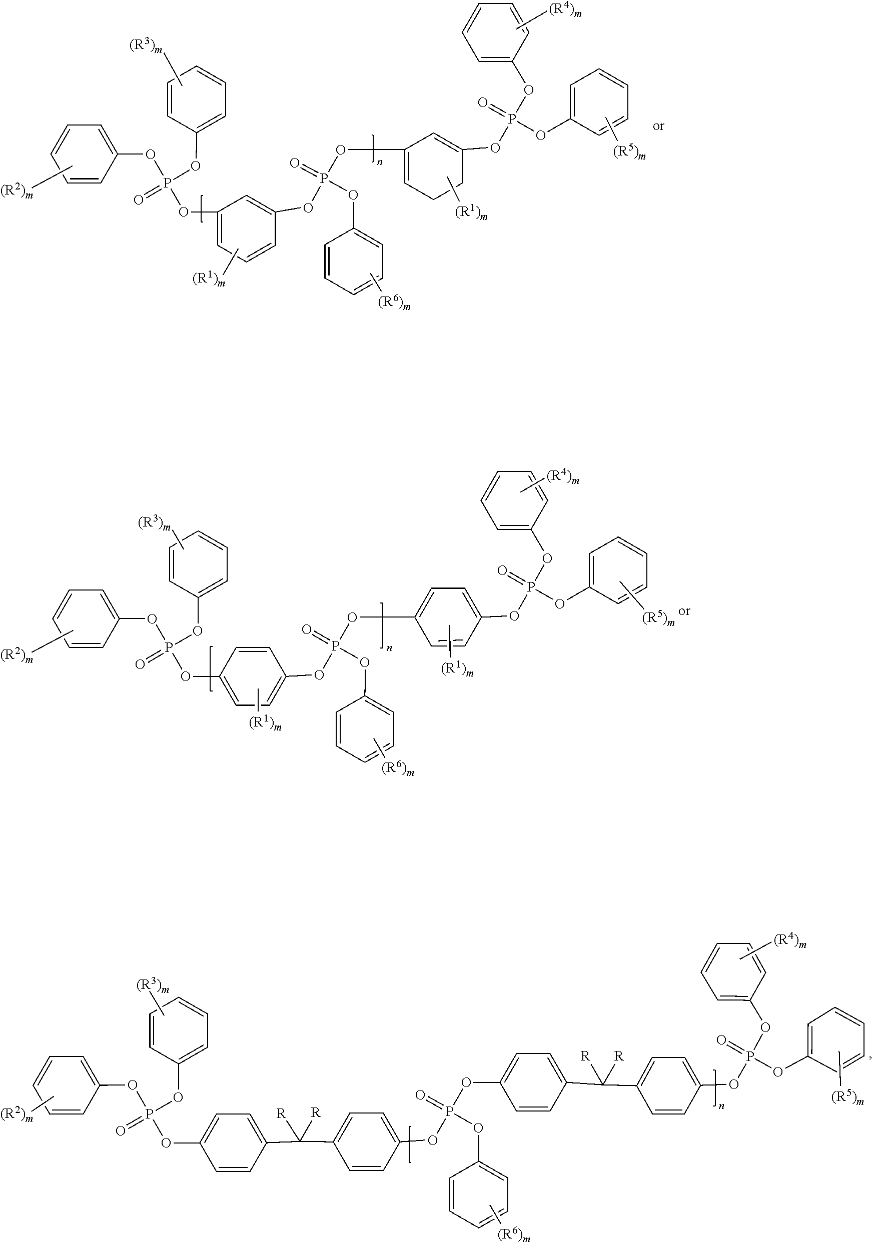

wherein
R¹=H, methyl, ethyl or isopropyl, but preferably H.
n=between 0 and 7, but preferably 0.
R²⁻⁶=H, methyl, ethyl or isopropyl, but preferably methyl. R⁶ is preferably identical to R⁴ and R⁵.
m=may be, but needs not be identical and is between 1, 2, 3, 4 and 5, but preferably 2.
R″=may be H, methyl, ethyl or cyclopropyl, but preferably methyl and H.

PX-200 is given as a concrete example:

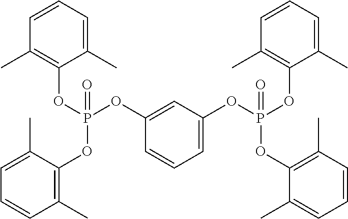 [SMILES: Cc1cccc(C)c1OP(=O)(Oc1cccc(OP(=O)(Oc2c(C)cccc2C)Oc2c(C)cccc2C)c1)Oc1c(C)cccc1C]

It is particularly preferable when at least one aromatic ester of polyphosphoric acid is employed. Such aromatic polyphosphates are obtainable for example from Daihachi Chemical under the name PX-200.

Further, as component H), the thermoplastic moulding materials according to the invention can for example comprise 5.0 to 30.0 wt %, preferably 10.0 to 25.0 wt %, in particular 12.0 to 20.0 wt %, for example about 16.0 wt %, of at least one metal phosphinate or phosphinic acid salt described hereinbelow as flame retardant, based on the total amount of components A), B), C), D), optionally E), optionally F), optionally G), optionally H) and optionally I).

Examples of preferred flame retardants of component H) are metal phosphinates derived from hypophosphorous acid, other than component B). A metal salt of hypophosphorous acid with Mg, Ca, Al or Zn as the metal may be employed for example. Particular preference is given here to aluminum hypophosphite.

Also suitable are phosphinic acid salts of formula (I) or/and diphosphinic acid salts of formula (II) or polymers thereof

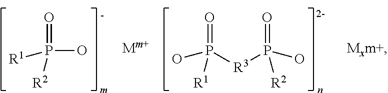

in which
R¹, R² are identical or different and represent hydrogen, C₁-C₆-alkyl, linear or branched, and/or aryl;
R³ represents C₁-C₁₀-alkylene, linear or branched, C₆-C₁₀-arylene, -alkylarylene or -arylalkylene;
M represents Mg, Ca, Al, Sb, Sn, Ge, Ti, Zn, Fe, Zr, Ce, Bi, Sr, Mn, Li, K and/or a protonated nitrogen base;
m=1 to 4; n=1 to 4; x=1 to 4, preferably m=3, x=3.

Preferably, R¹, R² are identical or different and represent hydrogen, methyl, ethyl, n-propyl, isopropyl, n-butyl, tert.-butyl, n-pentyl and/or phenyl.

Preferably, R³ represents methylene, ethylene, n-propylene, isopropylene, n-butylene, tert-butylene, n-pentylene, n-octylene or n-dodecylene, phenylene or naphthylene; methylphenylene, ethylphenylene, tert-butylphenylene, methylnaphthylene, ethylnaphthylene or tert-butylnaphthylene; phenylmethylene, phenylethylene, phenylpropylene or phenylbutylene.

Particularly preferably, R¹, R² are hydrogen, methyl, ethyl, and M is Al, particular preference is given to Al hypophosphite.

Production of the phosphinates is preferably effected by precipitation of the corresponding metal salts from aqueous solutions. However, the phosphinates may also be precipitated in the presence of a suitable inorganic metal oxide or sulfide as support material (white pigments, for example TiO₂, SnO₂, ZnO, ZnS, SiO₂). This accordingly affords surface-modified pigments which can be employed as laser-markable flame retardants for thermoplastic polyesters.

It is preferable when metal salts of substituted phosphinic acids are employed in which compared to hypophosphorous acid one or two hydrogen atoms have been replaced by phenyl, methyl, ethyl, propyl, isobutyl, isooctyl or radicals R′—CH—OH have been replaced by R′-hydrogen, phenyl, tolyl. The metal is preferably Mg, Ca, Al, Zn, Ti, Fe. Aluminum diethylphosphinate (DEPAL) is particularly preferred.

For a description of phosphinic acid salts or diphosphinic acid salts reference may be made to DE-A 199 60 671 and also to DE-A 44 30 932 and DE-A 199 33 901.

Further suitable flame retardants are, for example, halogen-containing flame retardants.

Suitable halogen-containing flame retardants are preferably brominated compounds, such as brominated diphenyl ether, brominated trimethylphenylindane (FR 1808 from DSB) tetrabromobisphenol A and hexabromocyclododecane.

Further suitable brominated flame retardants are brominated oligocarbonates (BC 52 or BC 58 from Great Lakes), having the structural formula:

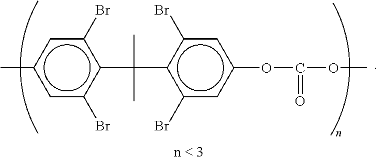

Especially suitable are polypentabromobenzyl acrylates, where n>4 (e.g. FR 1025 from ICL-IP having the formula:

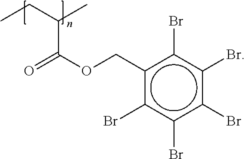

Preferred brominated compounds further include oligomeric reaction products (n>3) of tetrabromobisphenol A with epoxides (e.g. FR 2300 and 2400 from DSB) having the formula:

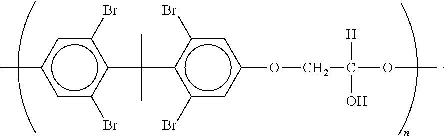

The brominated oligostyrenes preferably employed as flame retardants have an average degree of polymerization (number-average) between 3 and 90, preferably between 5 and 60, measured by vapor pressure osmometry in toluene. Cyclic oligomers are likewise suitable. In a preferred embodiment of the invention the brominated oligomeric styrenes have the formula I shown below in which R represents hydrogen or an aliphatic radical, in particular an alkyl radical, for example CH₂ or C₂H₅, and n represents the number of repeating chain building blocks. R¹ may be H or else bromine or else a fragment of a customary free radical former:

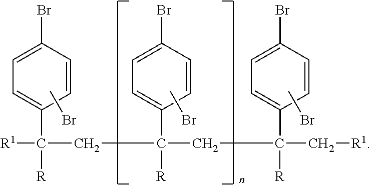

The value n may be 1 to 88, preferably 3 to 58. The brominated oligostyrenes comprise 40.0 to 80.0 wt %, preferably 55.0 to 70.0 wt %, of bromine. Preference is given to a product consisting predominantly of polydibromostyrene. The substances are meltable without decomposing, and soluble in tetrahydrofuran for example. Said substances may be produced either by ring bromination of—optionally aliphatically hydrogenated—styrene oligomers such as are obtained for example by thermal polymerization of styrene (according to DT-OS 25 37 385) or by free-radical oligomerization of suitable brominated styrenes. The production of the flame retardant may also be effected by ionic oligomerization of styrene and subsequent bromination. The amount of brominated oligostyrene necessary for endowing the polyamides with flame retardant properties depends on the bromine content. The bromine content in the moulding materials according to the invention is generally from 2.0 to 30.0 wt %, preferably from 5.0 to 12.0 wt %.

The brominated polystyrenes according to the invention are typically obtained by the process described in EP-A 047 549:

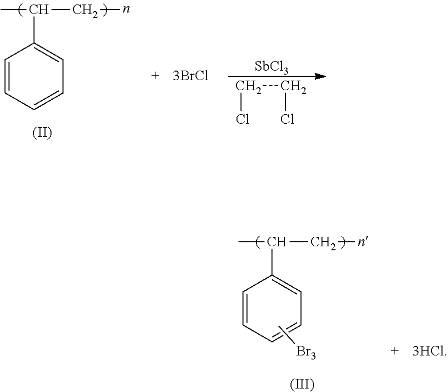

The brominated polystyrenes obtainable by this process and commercially available are predominantly ring-substituted tribrominated products. n′ (see III) generally has values of 125 to 1500 which corresponds to a molecular weight of 42500 to 235000, preferably of 130000 to 135000.

The bromine content (based on the content of ring-substituted bromine) is generally at least 50.0 wt %, preferably at least 60.0 wt % and in particular 65.0 wt %.

The commercially available pulverulent products generally have a glass transition temperature of 160° C. to 200° C. and are for example obtainable under the names SAYTEX® HP7010 from Albemarle and Pyrocheck® PB 68 from Ferro Corporation.

Mixtures of the brominated oligostyrenes with brominated polystyrenes may also be employed in the moulding materials according to the invention, the mixing ratio being freely choosable.

Suitable halogen-containing flame retardants are preferably ring-brominated polystyrene, brominated polybenzyl acrylates, brominated bisphenol A epoxide oligomers or brominated bisphenol A polycarbonates.

Also suitable are chlorine-containing flame retardants, Declorane Plus® from OxyChem being preferable.

In one embodiment of the invention no halogen-containing flame retardants are employed in the thermoplastic moulding materials according to the invention.

A flame retardant melamine compound suitable as component H) in the context of the present invention is a melamine compound which when added to glass fibre filled polyamide moulding materials reduces flammability and influences fire behavior in a fire retarding fashion, thus resulting in improved properties in the UL 94 tests and in the glow wire test.

The melamine compound is for example selected from melamine borate, melamine phosphate, melamine sulfate, melamine pyrophosphate, melam, melem, melon or melamine cyanurate or mixtures thereof.

The melamine cyanurate preferentially suitable according to the invention is a reaction product of preferably equimolar amounts of melamine (formula I) and cyanuric acid/isocyanuric acid (formulae Ia and Ib).

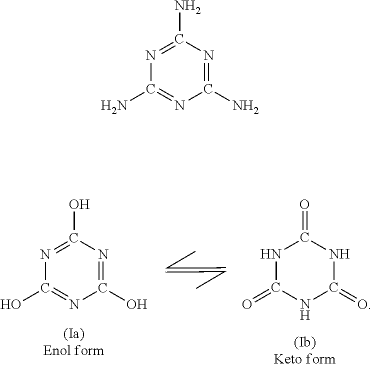

It is obtained for example by reaction of aqueous solutions of the starting compounds at 90° C. to 100° C. The commercially available product is a white powder having an average grain size d₅₀ of 1.5 to 7 μm and a d₉₉ value of less than 50 μm.

Further suitable compounds (often also described as salts or adducts) are melamine sulfate, melamine, melamine borate, oxalate, phosphate prim., phosphate sec, and pyrophosphate sec., melamine neopentyl glycol borate. According to the invention the moulding materials are preferably free from polymeric melamine phosphate (CAS no. 56386-64-2 or 218768-84-4).

This is to be understood as meaning melamine polyphosphate salts of a 1,3,5-triazine compound which have an average degree of condensation number n between 20 and 200 and a 1,3,5-triazine content of 1.1 to 2.0 mol of a 1,3,5-triazine compound selected from the group consisting of melamine, melam, melem, melon, ammeline, ammelide, 2-ureidomelamine, acetoguanamine, benzoguanamine and diaminophenyltriazine per mole of phosphorus atom. Preferably, the n-value of such salts is generally between 40 and 150 and the ratio of a 1,3,5-triazine compound per mole of phosphorus atom is preferably between 1.2 and 1.8. Furthermore, the pH of a 10 wt % aqueous slurry of salts produced according to EP-B1 095 030 will generally be more than 4.5 and preferably at least 5.0. The pH is typically determined by adding 25 g of the salt and 225 g of clean water at 25° C. into a 300 ml beaker, stirring the resultant aqueous slurry for 30 minutes and then measuring the pH. The abovementioned n-value, the number-average degree of condensation, may be determined by means of 31P solid-state NMR. J. R. van Wazer, C. F. Callis, J. Shoolery and R. Jones, J. Am. Chem. Soc., 78, 5715, 1956 discloses that the number of adjacent phosphate groups gives a unique chemical shift which permits clear distinction between orthophosphates, pyrophosphates, and polyphosphates.

Suitable guanidine salts are

| | CAS no. |
|---|---|
| guanidine carbonate | 593-85-1 |
| guanidine cyanurate prim. | 70285-19-7 |
| guanidine phosphate prim. | 5423-22-3 |
| guanidine phosphate sec. | 5423-23-4 |
| guanidine sulfate prim. | 646-34-4 |
| guanidine sulfate sec. | 594-14-9 |
| guanidine pentaerythritol borate | n.a. |
| guanidine neopentyl glycol borate | n.a. |
| and urea phosphate green | 4861-19-2 |
| urea cyanurate | 57517-11-0 |
| ammeline | 645-92-1 |
| ammelide | 645-93-2 |
| melem | 1502-47-2 |
| melon | 32518-77-7 |

In the context of the present invention “compounds” is to be understood as meaning not only for example benzoguanamine itself and the adducts/salts thereof but also the nitrogen-substituted derivatives and the adducts/salts thereof.

Also suitable are ammonium polyphosphate (NH₄PO₃)ₙ where n is about 200 to 1000, preferably 600 to 800, and tris(hydroxyethyl)isocyanurate (THEIC) of formula IV

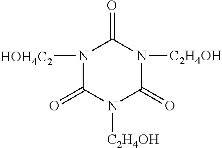

or the reaction products thereof with aromatic carboxylic acids Ar(COOH)ₘ which may optionally be present in a mixture with one another, wherein Ar represents a monocyclic, bicyclic or tricyclic aromatic six-membered ring system and m is 2, 3 or 4.

Examples of suitable carboxylic acids include phthalic acid, isophthalic acid, terephthalic acid, 1,3,5-benzenetricarboxylic acid, 1,2,4-benzenetricarboxylic acid, pyromellitic acid, mellophanic acid, prehnitic acid, 1-naphthoic acid, 2-naphthoic acid, naphthalenedicarboxylic acids, and anthracenecarboxylic acids.

Production is effected by reaction of the tris(hydroxyethyl)isocyanurate with the acids, the alkyl esters thereof or the halides thereof according to the processes in EP-A 584 567.

Such reaction products are a mixture of monomeric and oligomeric esters which may also be crosslinked. The degree of oligomerization is typically 2 to about 100, preferably 2 to 20. Preference is given to using mixtures of THEIC and/or reaction products thereof with phosphorus-containing nitrogen compounds, in particular (NH₄PO₃) n or melamine pyrophosphate or polymeric melamine phosphate. The mixing ratio for example of (NH₄PO₃) n to THEIC is preferably 90.0 to 50.0:10.0 to 50.0, in particular 80.0 to 50.0:50.0 to 20.0, wt % based on the mixture of such compounds.

Also suitable flame retardants are benzoguanidine compounds of formula V

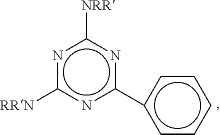

in which R, R′ represents straight-chain or branched alkyl radicals having 1 to 10 carbon atoms, preferably hydrogen, and in particular adducts thereof with phosphoric acid, boric acid and/or pyrophosphoric acid.

Also preferred are allantoin compounds of formula VI,

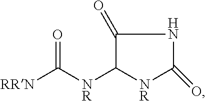

wherein R, R′ are as defined in formula V, and also the salts thereof with phosphoric acid, boric acid and/or pyrophosphoric acid and also glycolurils of formula VII or the salts thereof with the abovementioned acids

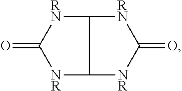

in which R is as defined in formula V.

Suitable products are commercially available or obtainable as per DE-A 196 14 424.

The cyanoguanidine (formula VIII) usable in accordance with the invention is obtainable for example by reacting calcium cyanamide with carbonic acid, the cyanamide produced dimerizing at from pH 9 to pH 10 to afford cyanoguanidine.

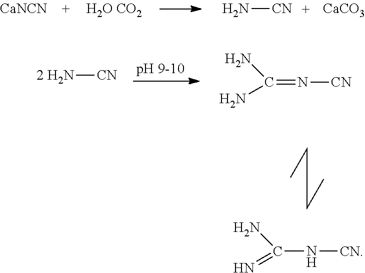

The commercially available product is a white powder having a melting point of 209° C. to 211° C.

It is particularly preferable to employ melamine cyanurate (for example Melapur® MC25 from BASF SE).

It is further possible to employ separate metal oxides such as antimony trioxide, antimony pentoxide, sodium antimonate and similar metal oxides. For a description of pentabromobenzyl acrylate and antimony trioxide or antimony pentoxide reference may be made to EP-A 0 624 626.

It is also possible to employ phosphorus, for example red phosphorus, as flame retardant. Red phosphorus may for example be employed in the form of a masterbatch.

Also contemplated are dicarboxylic acids of formula

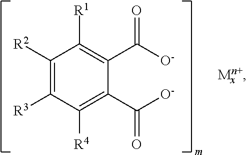

wherein
R¹ to R⁴ independently of one another represent halogen or hydrogen with the proviso that at least one radical R¹ to R⁴ represents halogen,
x=1 to 3, preferably 1, 2
m=1 to 9, preferably 1 to 3, 6, 9, in particular 1 to 3
n=2 to 3
M=alkaline earth metal, Ni, Ce, Fe, In, Ga, Al, Pb, Y, Zn, Hg.

Preferred dicarboxylic acid salts comprise as radicals R¹ to R⁴ independently of one another CI or bromine or hydrogen, especially preferably all radicals R¹ to R⁴ are CI or/and Br.

Be, Mg, Ca, Sr, Ba, Al, Zn, Fe are preferred as metals M.

Such dicarboxylic acid salts are commercially available or producible according to the processes described in U.S. Pat. No. 3,354,191.

Also employable as component H) are functional polymers. These may be flame retardant polymers for example. Such polymers are described in U.S. Pat. No. 8,314,202 for example and comprise 1,2-bis[4-(2-hydroxyethoxy)phenyl]ethanone repeating units. A further suitable functional polymer for increasing the amount of carbon residue is poly(2,6-dimethyl-1,4-phenyleneoxide) (PPPO).

### Component I)

As component I), the thermoplastic moulding composition contains from 0 to 25 wt %, preferably 0 to 20 wt %, more preferably 0 to 15 wt %, based on the total amount of components A), B), C), D), optionally E), optionally F), optionally G), optionally H) and optionally I), of at least one further additive,

If further additives are employed, the minimum amount is preferably 0.1 wt %, more preferably 0.25 wt %, most preferably 0.4 wt %, based on the total amount of components A), B), C), D), optionally E), optionally F), optionally G), optionally H) and optionally I).

If component I) is present, the maximum amount of component A) is decreased by the minimum amount of component I), so that the total amount of components A) to I) is still 100 wt %.

It is also possible to use mixtures of two or more additives.

The thermoplastic moulding compositions of the invention can comprise as component I) conventional processing aids, further stabilizers, oxidation retarders, agents to counteract decomposition by heat and decomposition by ultraviolet light, lubricants and mold-release agents, colourants other than the colourants mentioned as component C), nucleating agents, plasticizers, elastomeric polymers, etc.

The moulding compositions of the invention can comprise, as component 11), from 0.05 to 3% by weight, preferably from 0.1 to 1.5% by weight, and in particular from 0.1 to 1% by weight, based on the total amount of components A), B), C), D), optionally E), optionally F), optionally G), optionally H) and optionally I), of at least one lubricant.

Preference is given to the salts of Al, of alkali metals, or of alkaline earth metals, or esters or amides of fatty acids having from 10 to 44 carbon atoms, preferably having from 12 to 44 carbon atoms.

The metal ions are preferably alkaline earth metal and Al, particular preference being given to Ca or Mg.

Preferred metal salts are Ca stearate and Ca montanate, and also A1 stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

As component 12) the moulding materials according to the invention can comprise preferably 0.01% to 3% by weight, particularly preferably 0.02% to 2% by weight, in particular 0.05% to 1.0% by weight, of at least one heat stabilizer, based on the total amount of components A), B), C), D), optionally E), optionally F), optionally G), optionally H) and optionally I).

The heat stabilizers are preferably selected from copper compounds, secondary aromatic amines, sterically hindered phenols, phosphites, phosphonites and mixtures thereof.

As component I2), 0.05 to 3 wt %, preferably 0.1 to 2 wt %, in particular 0.1 to 1 wt % of at least one sterically hindered phenol antioxidant can be employed, based on the total amount of components A), B), C), D), optionally E), optionally F), optionally G), optionally H) and optionally I).

This component I2) preferably has a molecular weight of more than 500 g/mol, more preferably of more than 1000 g/mol. Additionally, component I) should preferably exhibit a high thermal stability, e.g. maximum of 5% weight loss, more preferably maximum of 2% weight loss, measured under nitrogen at 300° C. within a TGA (thermogravimetric analysis) experiment (40° C. to 120° C. with 10° C./min, isothermal the later temperature for 15 min followed by 120° C. to 600° C. at 20° C./min).

Component I2) has preferably at least one, more preferably at least two phenol groups substituted by at least one branched C₃₋₁₂-alkyl group as sterically hindering group. The substituted phenol groups are covalently linked with the structure of component 12).

Suitable sterically hindered phenols 12) are in principle all of the compounds which have a phenolic structure and which have at least one bulky group on the phenolic ring. A bulky group is for example a branched C₃₋₁₂-alkyl group, preferably a branched C₃₋₆-alkyl group, more preferably an isopropyl or tert.-butyl group.

It is preferable to use, for example, compounds of the formula

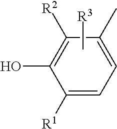

where:
R¹ and R² are an alkyl group, a substituted alkyl group, or a substituted triazole group, and where the radicals R¹ and R² may be identical or different, and R³ is an alkyl group, a substituted alkyl group, an alkoxy group, or a substituted amino group. The alkyl and alkoxy residues have preferably 1 to 12 carbon atoms, more preferably 1 to 6 carbon atoms. Substituents are preferably C₁₋₁₂-alkyl, more preferably C₁₋₆-alkyl, most preferably C₁₋₄-alkyl. At least one of R¹ to R³ is preferably a bulky group as defined above.

Antioxidants of the abovementioned type are described by way of example in DE-A 27 02 661 (U.S. Pat. No. 4,360,617).

Another group of preferred sterically hindered phenols is provided by those derived from substituted phenylcarboxylic acids, in particular from substituted phenylpropionic acids, which preferably have at least one bulky group on the phenyl group. They contain at least one, preferably two covalently linked substituted phenylcarboxylic acid unit(s) in their structure, which preferably have at least one bulky group on the phenyl group.

Preferred phenylcarboxylic acids are phenyl-C₁₋₁₂-carboxylic acids, more preferably phenyl-C₂₋₆-carboxylic acids. The phenyl group is preferably a phenol group having at least one bulky group on the phenolic ring, as indicated above. Thus, the above-mentioned sterically hindered phenols are preferably covalently linked with a C₁₋₁₂-alkane carboxylic acid, more preferably a linear C₂-6-alkane carboxylic acid.

Particularly preferred compounds from this class are compounds of the formula

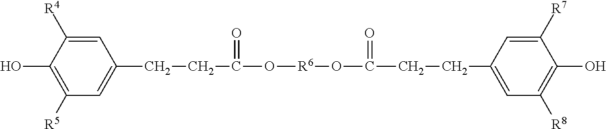

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds. At least one of R⁴ to R⁸ is a bulky group as defined above.

Preferred compounds corresponding to these formulae are

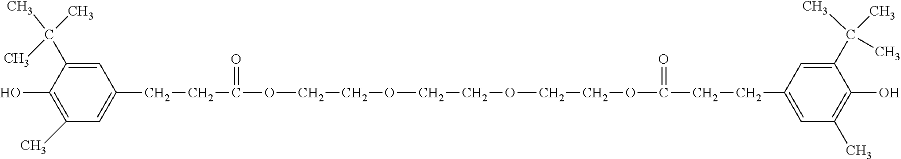 [SMILES: Cc1cc(CCC(=O)OCCOCCOCCOC(=O)CCc2cc(C)c(O)c(C(C)(C)C)c2)cc(C(C)(C)C)c1O]

(Irganox® 245 from BASF SE)

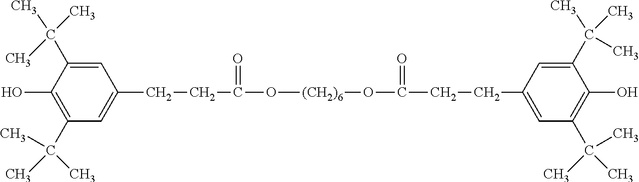

(Irganox® 259 from BASF SE)

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenyl) propionate], pentaerythrityl tetrakis[3-(3,5-di-tert-butyl-4-hydroxyphenyl) propionate] (Irganox® 1010 from BASF SE), distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl) propionate (Irganox® 259), pentaerythrityl tetrakis[3-(3,5-di-tert-butyl-4-hydroxyphenyl) propionate], and also N,N′-hexamethylenebis-3,5-di-tert-butyl-4-hydroxyhydrocinnamide (Irganox® 1098), and the products Irganox® 245 and Irganox® 1010 described above from BASF SE, which have particularly good suitability.

In some instances, sterically hindered phenols having not more than one sterically hindered group in ortho-position with respect to the phenolic hydroxy group have proven particularly advantageous; in particular when assessing colorfastness on storage in diffuse light over prolonged periods.

Furthermore, it is advantageous to employ sterically hindered phenol antioxidants which also have a sufficiently high molecular weight, preferably of more than 500 g/mol and especially a molecular weight above 1000 g/mol. Furthermore, they preferably exhibit a high thermal stability measured by TGA (thermogravimetric analysis) of less than 2% degradation up until 300° C. under nitrogen atmosphere.

The moulding compositions of the invention can comprise, as component 12), from 0.05 to 3% by weight, preferably from 0.1 to 1.5% by weight, and in particular from 0.1 to 1% by weight, based on the total amount of components A), B), C), D), optionally E), optionally F), optionally G), optionally H) and optionally I), of at least one copper stabilizer, preferably of a Cu(I)halide, in particular in a mixture with an alkali metal halide, preferably KI, in particular in the ratio 1:4, or of a sterically hindered phenol, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if a concentrate comprising the polyamide, and comprising a salt of monovalent copper, and comprising an alkali metal halide in the form of a solid, homogeneous solution is added to the moulding composition. By way of example, a typical concentrate is composed of from 79 to 95% by weight of polyamide and from 21 to 5% by weight of a mixture composed of copper iodide or copper bromide and potassium iodide. The copper concentration in the solid homogeneous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

Suitable polyamides for the concentrate are homopolyamides and copolyamides, in particular PA6.

According to a preferred embodiment of the present invention, the moulding compositions are free from copper, specifically from copper stabilizers, such as Cu/(I)halides, and combinations of Cu(I)halides with alkali metal halides.

More preferably, the thermoplastic moulding compositions of the present inventions are metal halide-free. Metal halide-free systems, so-called electro-friendly systems, are of high interest, since electro-mobility, electrification and connectivity are an increasing trend in almost all industries.

Therefore, the thermoplastic moulding composition is preferably free from metal halides, specifically Cu halides and alkali metal halides.

UV stabilizers that may be mentioned as component 13), the amounts of which used are generally up to 2 wt %, based on the total amount of components A), B), C), D), optionally E), optionally F), optionally G), optionally H) and optionally I), are various substituted resorcinols, salicylates, benzotriazoles, and benzophenones. Nigrosine can also be employed.

Materials that can be used as nucleating agents, component 14) are sodium phenylphosphinate, aluminum oxide, silicon dioxide, and also preferably talc.

The moulding compositions of the invention can comprise, as component 15), from 0.1 to 10% by weight, preferably 0.5 to 5 wt %, more preferably 1 to 4 wt %, based on the total amount of components A), B), C), D), optionally E), optionally F), optionally G), optionally H) and optionally I), of at least one plasticizer.

Kunststoff-Handbuch, Band VI Polyamide, Carl Hanser Verlag München 1966, Section 3.4.2.1. b) on pages 238 and 239 in connection with Table 7 describes suitable plasticizers. They can be divided in aromatic hydroxy compounds, sulfonamides and further plasticizers like lactams, lactones, alcohols etc.

Suitable plasticizers are for example poly(trimethylene ether) glycol (PPD), preferably poly(trimethylene ether) glycol (PPD) having a number average molecular weight of 255 and poly(trimethylene ether) glycol benzoate (PPDB), N-butyl benzene sulfonamide (NBBS), polyethylene glycol dibenzoate (Mₙ=410), poly(1,2-propylene glycol)dibenzoate (Mₙ=400), monomeric amides, specifically sulfonamides, for example N-alkyl aryl sulfonamides, p-alkyl benzene sulfonamides and guanidine-based compounds, a mixture of lactam compounds and polyethylene glycol, an aromatic ester of poly(trimethylene ether) glycol with a number average molecular weight of 1000 or less or compounds of the general formula (1).

R₁—O—(CH₂CH₂—O—)ₙR₂ (1)

with n=1 to 10
R¹, R² independently H, C₁₋₁₂-alkyl, phenyl or tolyl,
   having a boiling point of more than 250° C.

A preferred plasticizer of general formula (1) is based on triethylene glycol, tetraethylene glycol, pentaethylene glycol or mixtures thereof. Most preferred is tetraethylene glycol. Therefore, n most preferably has a value of from 3.8 to 4.2, most preferably of 4.

Tetraethylene glycol is non-toxic and has a high plasticizing efficiency. When compared with sulfonamides and lactams, only half the amount of tetraethylene glycol is necessary to achieve the same plasticizing effect and the same decrease of the glass transition temperature. Therefore, in a preferred embodiment, the thermoplastic moulding composition comprises a compound of formula (1) as plasticizer, in the case that a plasticizer is present as component 15).

As component 16), the moulding compositions of the present invention can comprise 1 to 45 wt %, preferably 2 to 40 wt %, based on the total amount of components A), B), C), D), optionally E), optionally F), optionally G), optionally H) and optionally I), of at least one elastomeric polymer.

Component 16) can be selected from all elastomeric polymers, impact modifiers, elastomers or rubbers which are suitable for polyamide moulding compositions.

Preferably component 16) is selected from
b1) copolymers of ethylene with at least one comonomer selected from C₃-12-Olefins, C₁₋₁₂-alkyl (meth)acrylates, (meth)acrylic acid and maleic anhydride as component B1),
b2) polyethylene or polypropylene as component B2),
wherein components B1) and B2) may also be additionally grafted with maleic anhydride, preferably from ethylene-propylene rubbers, ethylene-propylene-diene-rubbers, ethylene-butyl acrylate copolymers, copolymers of ethylene and/or propylene and maleic anhydride and mixtures thereof.

These elastomeric polymers (also often termed impact modifiers, elastomers, or rubbers) are very generally copolymers preferably composed of at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, vol. 14/1 (Georg-Thieme-Verlag, Stuttgart, Germany, 1961), pages 392 to 406, and in the monograph by C.B. Bucknall, Toughened Plastics (Applied Science Publishers, London, U K, 1977).

Examples of suitable elastomers are obtainable for example from Lyondellbasell under the designations Lucalen A2540D and Lucalen A2700M. Lucalen A2540D is a low density polyethylene comprising a butyl acrylate comonomer. It has a density of 0.923 g/cm³ and a Vicat softening temperature of 85° C. and a melting temperature of 103° C. at a butyl acrylate proportion of 6.5% by weight.

Lucalen A2700M is a low density polyethylene likewise comprising a butyl acrylate comonomer. It has a density of 0.924 g/cm³, a Vicat softening temperature of 60° C. and a melting temperature of 95° C.

The polymer resin Exxelor™ VA 1801 from ExxonMobil is a semicrystalline ethylene copolymer functionalized with maleic anhydride by reactive extrusion and having an intermediate viscosity. The polymer backbone is fully saturated. The density is 0.880 g/cm³ and the proportion of maleic anhydride is typically in the range from 0.5% to 1.0% by weight.

Carbon black or nigrosine are for example used as colourants other than the colourants mentioned under C) and F).

As component 17), the moulding compositions of the present invention can comprise 0.1 to 3 wt %, preferably 0.2 to 2.5 wt %, based on the total amount of components A), B), C), D), optionally E), optionally F), optionally G), optionally H) and optionally I), of at least one flow enhancer.

Examples for suitable flow enhancers are branched, hyperbranched or dendritic components, usually macromolecules like polymers containing functional groups like —NH₂, —OH, —COOH, or —COOCH₃.

The macromolecules may be for example polyamide based polymers or polyesters.

Examples are CYD-701, CYD-C600, CYD-819, CYD-816A (all Weihai CY Dendrimer Technology Co, Ltd.), HyPer C100 (Wuhan HyPerBranched Polymers Science Technology Co., Ltd.), TER-PA9 from TER HELL & Co. GmbH and Bruggolen TP-P1507 and TP-P1810 from L. Brüggemann GmbH & Co. KG.

A dendrimer consists of two types of structural units: terminal units on the globular surface and dendritic units inside. As such, dendrimers are well defined in structure. On the other hand, a hyperbranched polymer has three types of structural units: dendritic units, linear units and terminal units. The terminal units are always located at the terminals, however, the dendritic units and linear units are randomly distributed within the macromolecular framework, resulting in irregular structures.

### Compositions

The compositions according to the present invention are characterized by a very high colour stability, especially at high temperatures, whereby the smell of the compositions is reduced or not present, which is obtained by employing a combination of i) at least one of sodium hypophosphite or a hydrate of sodium hypophosphite (component B)) and ii) at least one acid scavenger (component D)), in the presence of at least one sulfur containing colourant comprising at least one not covalently bonded sulfur atom (component C)).

The inventive thermoplastic moulding composition therefore comprises
a) from 10 to 99.97% by weight, preferably 20 to 85% by weight, more preferably 30 to 75% by weight of at least one thermoplastic polyamide different from component E), as component A), most preferably, component A) is PA 6, PA 66, PA 6/66, PA 66/6 and/or PA 6/6.36;
b) from 0.01 to 0.5% by weight, preferably 0.06 to 0.45% by weight, more preferably 0.1 to 0.4% by weight of at least one of sodium hypophosphite or a hydrate of sodium hypophosphite, as component B),
c) from 0.01 to 5% by weight of a colourant comprising at least one not covalently bonded sulfur atom or two or more colourants comprising at least one sulfur containing colourant comprising at least one not covalently bonded sulfur atom, preferably an orange colourant comprising at least one not covalently bonded sulfur atom or two or more colourants resulting in the colour orange comprising at least one sulfur containing colourant comprising at least one not covalently bonded sulfur atom, as component C),
d) from 0.01 to 2% by weight, preferably 0.02 to 1.8% by weight, more preferably 0.03 to 1,5% by weight of at least one acid scavenger, as component D),
e) from 0 to 20% by weight, preferably from 0.01 to 18% by weight, more preferably from 0.1 to 17% by weight, most preferably from 1 to 16% by weight of at least one polyamide 6I/6T, as component E), preferably, the molar ratio of 6I units to 6T units in the polyamide 6I/6T is in the range from 1:1 to 3:1, more preferably in the range of from 1.5:1 to 2.5:1 and most preferably in the range of from 1.8:1 to 2.3:1;
f) from 0 to 5% by weight, preferably 0.1 to 3.5% by weight, more preferably 0.5 to 2.5% by weight of at least one laser inscription additive, preferably at least one pigment system comprising a metal oxide or a mixture of two or more metal oxides, more preferably antimony trioxide, titanium dioxide, glimmer, tin oxide, ferrous oxide, zinc oxide, aluminum oxide, bismuth trioxide, or mixtures thereof, as component F),
g) from 0 to 60% by weight, preferably 10 to 55% by weight, more preferably 15 to 50% by weight of at least one fibrous and/or particulate filler, as component G), preferably glass fibres, which glass fibres are more preferably modified with a size system or an adhesion promoter/adhesion promoter system which is further most preferably based on silane,
h) from 0 to 55% by weight, preferably 1 to 35% by weight, more preferably 2 to 25% by weight of at least one flame retardant additive, as component H), and
i) from 0 to 25% by weight, preferably 0.1 to 20% by weight, more preferably 0.25 to 15% by weight of at least one further additive, as component I), where the total of the percentages by weight of components A) to I) is 100% by weight.

Suitable and preferred components A), B), C), D), E), F), G), H) and I) and amounts of said components in the inventive thermoplastic moulding composition are mentioned above.

The inventive thermoplastic moulding composition is a filled composition, i.e. comprising from 10 to 60% by weight, preferably 15 to 55% by weight, more preferably 20 to 50% by weight of at least one fibrous and/or particulate filler, as component G), or a non-filled composition, i.e comprising 0% by weight of a fibrous and/or particulate filler, as component G).

In one embodiment, the thermoplastic moulding composition of the present invention is a filled composition comprising
a) from 10 to 89.97% by weight, preferably 20 to 80% by weight, more preferably 30 to 75% by weight of at least one thermoplastic polyamide different from component E), as component A), most preferably, component A) is PA 6, PA 66, PA 6/66, PA 66/6 and/or PA 6/6.36;
b) from 0.01 to 0.5% by weight, preferably 0.06 to 0.45% by weight, more preferably 0.1 to 0.4% by weight of at least one of sodium hypophosphite or a hydrate of sodium hypophosphite, as component B),
c) from 0.01 to 5% by weight of a colourant comprising at least one not covalently bonded sulfur atom or two or more colourants comprising at least one sulfur containing colourant comprising at least one not covalently bonded sulfur atom, preferably an orange colourant comprising at least one not covalently bonded sulfur atom or two or more colourants resulting in the colour orange comprising at least one sulfur containing colourant comprising at least one not covalently bonded sulfur atom, as component C),
d) from 0.01 to 2% by weight, preferably 0.02 to 1.8% by weight, more preferably 0.03 to 1,5% by weight of at least one acid scavenger, as component D),
e) from 0 to 20% by weight, preferably from 0.01 to 18% by weight, more preferably from 0.1 to 17% by weight, most preferably from 1 to 16% by weight of at least one polyamide 6I/6T, as component E), preferably, the molar ratio of 6I units to 6T units in the polyamide 6I/6T is in the range from 1:1 to 3:1, more preferably in the range of from 1.5:1 to 2.5:1 and most preferably in the range of from 1.8:1 to 2.3:1;
f) from 0 to 5% by weight, preferably 0.1 to 3.5% by weight, more preferably 0.5 to 2.5% by weight of at least one laser inscription additive, preferably at least one pigment system comprising a metal oxide or a mixture of two or more metal oxides, more preferably antimony trioxide, titanium dioxide, glimmer, tin oxide, ferrous oxide, zinc oxide, aluminum oxide, bismuth trioxide, or mixtures thereof, as component F),
g) from 10 to 60% by weight, preferably 15 to 55% by weight, more preferably 20 to 50% by weight of at least one fibrous and/or particulate filler, as component G), preferably glass fibres, which glass fibres are more preferably modified with a size system or an adhesion promoter/adhesion promoter system which is further most preferably based on silane,
h) from 0 to 55% by weight, preferably 1 to 35% by weight, more preferably 2 to 25% by weight of at least one flame retardant additive, as component H), and
i) from 0 to 25% by weight, preferably 0.1 to 20% by weight, more preferably 0.25 to 15% by weight of at least one further additive, as component I),
where the total of the percentages by weight of components A) to I) is 100% by weight.

Suitable and preferred components A), B), C), D), E), F), G), H) and I) and amounts of said components in the inventive thermoplastic moulding composition are mentioned above.

Due to its colour stability especially at high temperatures, the inventive thermoplastic moulding composition is especially useful for the provision of coloured products, preferably orange-coloured products, which are for example used for the provision of high-voltage systems.

The inventive thermoplastic moulding compositions composition therefore more preferably comprises
a) from 10 to 99.97% by weight, preferably 20 to 85% by weight, more preferably 30 to 75% by weight of at least one thermoplastic polyamide different from component E), as component A), most preferably, component A) is PA 6, PA 66, PA 6/66, PA 66/6 and/or PA 6/6.36;
b) from 0.01 to 0.5% by weight, preferably 0.06 to 0.45% by weight, more preferably 0.1 to 0.4% by weight of at least one of sodium hypophosphite or a hydrate of sodium hypophosphite, as component B),
c) from 0.01 to 5% by weight of a colourant comprising at least one not covalently bonded sulfur atom or two or more colourants comprising at least one sulfur containing colourant comprising at least one not covalently bonded sulfur atom, preferably an orange colourant comprising at least one not covalently bonded sulfur atom or two or more colourants resulting in the colour orange comprising at least one sulfur containing colourant comprising at least one not covalently bonded sulfur atom, with particular preference for shades corresponding in the RAL colour system to the colour numbers RAL 2001, RAL 2003, RAL 2004, RAL 2007, RAL 2008, RAL 2009, RAL 2010 and RAL 2011, and very particular preference for the shades corresponding in the RAL colour system to the colour numbers RAL 2003, RAL 2008 and RAL 2011, as component C),
d) from 0.01 to 2% by weight, preferably 0.02 to 1.8% by weight, more preferably 0.03 to 1,5% by weight of at least one acid scavenger, as component D),
e) from 0 to 20% by weight, preferably from 0.01 to 18% by weight, more preferably from 0.1 to 17% by weight, most preferably from 1 to 16% by weight of at least one polyamide 6I/6T, as component E), preferably, the molar ratio of 6I units to 6T units in the polyamide 6I/6T is in the range from 1:1 to 3:1, more preferably in the range of from 1.5:1 to 2.5:1 and most preferably in the range of from 1.8:1 to 2.3:1;
f) from 0 to 5% by weight, preferably 0.1 to 3.5% by weight, more preferably 0.5 to 2.5% by weight of at least one laser inscription additive, preferably at least one pigment system comprising a metal oxide or a mixture of two or more metal oxides, more preferably antimony trioxide, titanium dioxide, glimmer, tin oxide, ferrous oxide, zinc oxide, aluminum oxide, bismuth trioxide, or mixtures thereof, as component F),
g) from 0 to 60% by weight, preferably 10 to 55% by weight, more preferably 15 to 50% by weight of at least one fibrous and/or particulate filler, as component G), preferably glass fibres, which glass fibres are more preferably modified with a size system or an adhesion promoter/adhesion promoter system which is further most preferably based on silane,
h) from 0 to 55% by weight, preferably 1 to 35% by weight, more preferably 2 to 25% by weight of at least one flame retardant additive, as component H), and
i) from 0 to 25% by weight, preferably 0.1 to 20% by weight, more preferably 0.25 to 15% by weight of at least one further additive, as component I),
where the total of the percentages by weight of components A) to I) is 100% by weight.

Suitable and preferred components A), B), C), D), E), F), G), H) and I) and amounts of said components in the inventive thermoplastic moulding composition are mentioned above.

In one embodiment, the thermoplastic moulding composition of the present invention is a filled and coloured composition comprising
a) from 10 to 89.97% by weight, preferably 20 to 80% by weight, more preferably 30 to 75% by weight of at least one thermoplastic polyamide different from component E), as component A), most preferably, component A) is PA 6, PA 66, PA 6/66, PA 66/6 and/or PA 6/6.36;
b) from 0.01 to 0.5% by weight, preferably 0.06 to 0.45% by weight, more preferably 0.1 to 0.4% by weight of at least one of sodium hypophosphite or a hydrate of sodium hypophosphite, as component B),
c) from 0.01 to 5% by weight of a colourant comprising at least one not covalently bonded sulfur atom or two or more colourants comprising at least one sulfur containing colourant comprising at least one not covalently bonded sulfur atom, preferably an orange colourant comprising at least one not covalently bonded sulfur atom or two or more colourants resulting in the colour orange comprising at least one sulfur containing colourant comprising at least one not covalently bonded sulfur atom, with particular preference for shades corresponding in the RAL colour system to the colour numbers RAL 2001, RAL 2003, RAL 2004, RAL 2007, RAL 2008, RAL 2009, RAL 2010 and RAL 2011, and very particular preference for the shades corresponding in the RAL colour system to the colour numbers RAL 2003, RAL 2008 and RAL 2011, as component C),
d) from 0.01 to 2% by weight, preferably 0.02 to 1.8% by weight, more preferably 0.03 to 1,5% by weight of at least one acid scavenger, as component D),
e) from 0 to 20% by weight, preferably from 0.01 to 18% by weight, more preferably from 0.1 to 17% by weight, most preferably from 1 to 16% by weight of at least one polyamide 6I/6T, as component E), preferably, the molar ratio of 6I units to 6T units in the polyamide 6I/6T is in the range from 1:1 to 3:1, more preferably in the range of from 1.5:1 to 2.5:1 and most preferably in the range of from 1.8:1 to 2.3:1;
f) from 0 to 5% by weight, preferably 0.1 to 3.5% by weight, more preferably 0.5 to 2.5% by weight of at least one laser inscription additive, preferably at least one pigment system comprising a metal oxide or a mixture of two or more metal oxides, more preferably antimony trioxide, titanium dioxide, glimmer, tin oxide, ferrous oxide, zinc oxide, aluminum oxide, bismuth trioxide, or mixtures thereof, as component F),
g) from 10 to 60% by weight, preferably 15 to 55% by weight, more preferably 20 to 50% by weight of at least one fibrous and/or particulate filler, as component G), preferably glass fibres, which glass fibres are more preferably modified with a size system or an adhesion promoter/adhesion promoter system which is further most preferably based on silane,
h) from 0 to 55% by weight, preferably 1 to 35% by weight, more preferably 2 to 25% by weight of at least one flame retardant additive, as component H), and
i) from 0 to 25% by weight, preferably 0.1 to 20% by weight, more preferably 0.25 to 15% by weight of at least one further additive, as component I),
where the total of the percentages by weight of components A) to I) is 100% by weight. Suitable and preferred components A), B), C), D), E), F), G), H) and I) and amounts of said components in the inventive thermoplastic moulding composition are mentioned above.

The thermoplastic moulding compositions of the invention can be produced by processes known per se, by mixing the starting components A), B), C), D) and optionally E), optionally F), optionally G), optionally H) and optionally I) in conventional mixing apparatus, such as screw-based extruders, Brabender mixers, or Banbury mixers, and then extruding the same. After extrusion, the extrudate can be cooled and pelletized. It is also possible to premix individual components and then to add the remaining starting materials individually and/or likewise in the form of a mixture. The barrel temperatures are generally from 230 to 330° C.

### Application

These materials are suitable for the production of moulded articles, fibres, films and extruded articles, preferably moulded articles, which are more preferably coloured and which are most preferably coloured orange.

The present invention therefore further relates to a moulded or extruded article, preferably a moulded article, more preferably a coloured moulded article, most preferably an orange coloured moulded article made of a thermoplastic moulding composition according to the present invention or obtained by the process according to the present invention.

The inventive thermoplastic moulding composition can be used in the electrical and electronic sector to produce for example plugs, plug parts, plug connectors, membrane switches, printed circuit board modules, microelectronic components, coils, I/O plug connectors, plugs for printed circuit boards (PCBs), plugs for flexible printed circuits (FPCs), plugs for flexible integrated circuits (FFCs), high-speed plug connections, terminal strips, connector plugs, device connectors, cable-harness components, circuit mounts, circuit-mount components, three-dimensionally injection-moulded circuit mounts, electrical connection elements, and mechatronic components.

Since preferred thermoplastic moulding compositions of the present invention are coloured orange, the moulded or extruded article is in one preferred embodiment a high-voltage component, especially a high-voltage components for electromobility. Said high-voltage component is more preferably, selected from the group consisting of covers for electrics or electronics, control devices, covers/housings for fuses, relays, battery cell modules, fuse holders, fuse plugs, terminals, cable holders or sheathings, especially sheathings of high-voltage bus bars and high-voltage distributor bus bars.

The process preferably comprises
i) mixing the components A), B), C), D) and optionally E), optionally F), optionally G), optionally H) and optionally I),
ii) extruding the composition obtained in step i) to give strands,
iii) cooling the strands obtained in step ii) until pelletizable, pelletizing and optionally drying, and
iv) subjecting the pelletized strands obtained in step iii) to further processing preferably by injection moulding or by extrusion methods, including profile extrusion.

The inventors found that polyamide compositions comprising a combination of sodium hypophosphite or a hydrate of sodium hypophosphite and at least one sulphur containing colorant comprising at least one not covalently bonded sulphur atom, having a very high colour stability, especially at high temperatures and having no or a reduced hydrogen sulfide smell can be obtained by employing at least one acid scavenger.

The present invention therefore further relates to the use of at least one acid scavenger in a thermoplastic moulding composition comprising i) at least one thermoplastic polyamide, ii) at least one of sodium hypophosphite or a hydrate of sodium hypophosphite and iii) a colourant comprising at least one not covalently bonded sulfur atom or two or more colourants comprising at least one sulfur containing colourant comprising at least one not covalently bonded sulfur atom, for improving the odour of said thermoplastic moulding compositions.

### EXAMPLES

The following components were used:
Component A1: Polyamide-66 having a viscosity number of 115-135 ml/g, determined as 0.5 wt % solution in 96% wt sulfuric acid at 25° C. according to ISO 307:2019 (Ultramid® A24 from BASF SE)
Component A2: Polyamide 6I/6T having a relative viscosity of 1.47-1.57, determined as 0.5% solution in m-kresol at 20° C. according to ISO 307:2019 (Grivory® G21 Natural from EMS)
Component B: Commercially available glass fibers for polyamides having a length of 4.5 mm and diameter of 10 μm (Standard E glass fiber)
Component C: Commercially available calcium stearate (CAS: 1592-23-0)
Component D1: Commercially available Irganox® 1098 from BASF SE
Component D2: Commercially available sodium hypophosphite monohydrate (CAS: 10039-56-2)
Component E1: Commercially available zinc sulfide (CAS: 1314-98-3)
Component E2: Pigment mixture in order to achieve an orange color in RAL2003, comprising at least one sulfur containing colourant comprising at least one not covalently bonded sulfur atom
Component F1: Commercially available hydrotalcite ([Carbonato (2-)]hexadecahydroxybis(aluminium)hexa-magnesium 713, CAS: 11097-59-9) known under the tradename Hycite® 713 from BASF SE
Component F2: Commercially available zinc oxide (CAS: 1314-13-2)
Component F3: Commercially available zinc stannate (CAS: 12036-37-2) known under the trade name FLAMTARD® S from William Blythe Ltd.
Component F4: Commercially available zinc borate anhydrous (CAS: 12767-90-7) know under the trade name Firebrake® 500 from Nordmann, Rassmann GmbH
Component F5: Commercially available zinc borate hydrate (CAS: 138265-88-0) know under the trade name Firebrake® ZB from Nordmann, Rassmann GmbH
Component F6: Commercially available zinc ricinoleate know under the trade name TEGO Sorb® PY 88 TQ from Evonik
Component F7: Commercially available magnesium hydroxide, surface modified (CAS: 1309-42-8) known under the trade name MAGNIFIN® H-5 IV from Martinswerke
Component F8: Commercially available lanthanum carbonate (CAS: 587-26-8)

### Preparation of the Granules:

The natural-colored polyamide granules were dried at 80° C. to a moisture content of less than 0.1% by weight, all other ingredients were pre-mixed in a tumble mixer for 10 minutes. In the next step, the dried polyamide granulates together with the dry blended ingredients were melt-extruded using a twin-screw extruder having a diameter of 25 mm and a L/D ratio of 44. The extruder was operated with a rotating speed of 240 min-1, a throughput of 16 kg/h and with a cylinder temperature of 280° C. to 310° C. employing a flat temperature profile. The obtained strands were cooled in a water bath, granulated and packed in aluminum foil bags. After storage for several days, the bags were reopened, and the smell/odor was validated.

| | Comp. | Comp. | Comp. | | | | | | | | | |
|---|---|---|---|---|---|---|---|---|---|---|---|---|
| | Ex. 1 | Ex. 2 | Ex. 3 | Ex. 1 | Ex. 2 | Ex. 3 | Ex. 4 | Ex. 5 | Ex. 6 | Ex. 7 | Ex. 8 | Ex. 9 |
| Component A1 | 53.94 | 53.74 | 63.85 | 63.8 | 53.69 | 53.54 | 53.54 | 53.54 | 53.54 | 52.74 | 53.54 | 53.54 |
| Component A2 | 10 | 10 | | | 10 | 10 | 10 | 10 | 10 | 10 | 10 | 10 |
| Component B | 35 | 35 | 35 | 35 | 35 | 35 | 35 | 35 | 35 | 35 | 35 | 35 |
| Component C | 0.3 | 0.3 | 0.3 | 0.3 | 0.3 | 0.3 | 0.3 | 0.3 | 0.3 | 0.3 | 0.3 | 0.3 |
| Component D1 | 0.15 | 0.15 | 0.15 | 0.15 | 0.15 | 0.15 | 0.15 | 0.15 | 0.15 | 0.15 | 0.15 | 0.15 |
| Component D2 | | 0.2 | 0.2 | 0.2 | 0.2 | 0.2 | 0.2 | 0.2 | 0.2 | 0.2 | 0.2 | 0.2 |
| Component E1 | 0.34 | 0.34 | 0.5 | 0.5 | 0.34 | 0.34 | 0.34 | 0.34 | 0.34 | 0.34 | 0.34 | 0.34 |
| Component E2 | 0.27 | 0.27 | | | 0.27 | 0.27 | 0.27 | 0.27 | 0.27 | 0.27 | 0.27 | 0.27 |
| Component F1 | | | | 0.05 | 0.05 | | | | | | | |
| Component F2 | | | | | | 0.2 | | | | | | |
| Component F3 | | | | | | | 0.2 | | | | | |
| Component F4 | | | | | | | | 0.2 | | | | |
| Component F5 | | | | | | | | | 0.2 | | | |
| Component F6 | | | | | | | | | | 1 | | |
| Component F7 | | | | | | | | | | | 0.2 | |
| Component F8 | | | | | | | | | | | | 0.2 |
| | no | smell | smell | no | no | no | no | no | no | no | no | no |
| | smell | | | smell | smell | smell | smell | smell | smell | smell | smell | smell |

The above examples illustrate that by employing an acid scavenger in polyamide compositions comprising a combination of sodium hypophosphite and at least one sulfur containing colourant comprising at least one not covalently bonded sulfur atom, generally present in colourants or colourant mixtures, a hydrogen sulfide formation and therefore the hydrogen sulfide smell can be supressed.

1.-15. (canceled)

16. A thermoplastic moulding composition comprising:
a) from 10 to 99.97% by weight of at least one thermoplastic polyamide different from component E), as component A);
b) from 0.01 to 0.5% by weight of at least one of sodium hypophosphite or a hydrate of sodium hypophosphite, as component B);
c) from 0.01 to 5% by weight of a colourant comprising at least one not covalently bonded sulfur atom or two or more colourants comprising at least one sulfur containing colourant comprising at least one not covalently bonded sulfur atom, as component C);
d) from 0.01 to 2% by weight of at least one acid scavenger, as component D);
e) from 0 to 20% by weight of at least one polyamide 6I/6T, as component E);
f) from 0 to 5% by weight of at least one laser inscription additive, as component F);
g) from 0 to 60% by weight of at least one fibrous or particulate filler, as component G);
h) from 0 to 55% by weight of at least one flame retardant additive, as component H); and
i) from 0 to 25% by weight of at least one further additive, as component I),
wherein the total of the percentages by weight of components A) to I) is 100% by weight.

17. The thermoplastic moulding composition according to according to claim 16, wherein component C) is an orange colourant comprising at least one not covalently bonded sulfur atom or two or more colourants resulting in the colour orange comprising at least one sulfur containing colourant comprising at least one not covalently bonded sulfur atom.

18. The thermoplastic moulding composition according to according to claim 16, wherein component F) is at least one pigment system comprising a metal oxide or a mixture of two or more metal oxides.

19. The thermoplastic moulding composition according to according to claim 16, wherein component A) is selected from aliphatic and semiaromatic polyamides.

20. The thermoplastic moulding composition according to according to claim 19, wherein the aliphatic and semiaromatic polyamides are selected from the group consisting of PA 6, PA 66, PA 46, PA 6/66, PA 66/6, PA 6/636, PA610, PA 6T/6, PA 6T/6I, PA 6T/6I/66, PA 9T and PA 6T/66, and mixtures thereof.

21. The thermoplastic moulding composition according to claim 16, wherein the amount of component B) is from 0.06 to 0.45% by weight.

22. The thermoplastic moulding composition according to claim 16, wherein component D) is at least one organic or inorganic base.

23. The thermoplastic moulding composition according to claim 22, wherein the at least one organic or inorganic base is selected from the group consisting of oxides, hydroxides, carbonates, silicates, borates, stannates, mixed oxides-hydroxides, oxides-hydroxides-carbonates, hydroxides-silicates or hydroxides-borates of at least one element selected from the group consisting of alkali metals, alkaline earth metals, elements of the boron group (group 13 in the periodic table IUPAC version), zinc and tin; salts of fatty acids; hydrotalcites; ricinoleates and mixtures thereof.

24. The thermoplastic moulding composition according to claim 16, wherein component E) consists of units derived from hexamethylenediamine, from terephthalic acid and from isophthalic acid.

25. The thermoplastic moulding composition according to claim 16, wherein component G) is selected from the group consisting of carbon fibres, glass beads, e.g. solid or hollow glass beads, glass fibres, ground glass, amorphous quartz glass, aluminum borosilicate glass having an alkali content of about 1%, amorphous silica, quartz flour, alkaline earth metal silicate, calcium silicate, calcium metasilicate, magnesium carbonate, kaolin, calcined kaolin, chalk, kyanite, powdered or milled quartz, mica, phlogopite, barium sulfate, feldspar, wollastonite, montmorillonite, boehmite, bentonite, vermiculite, hectorite, laponite, pseudoboehmite of formula AIO(OH), magnesium carbonate, talc, aramid fibres, potassium titanate fibres, barium carbonate, alkaline earth metal oxide, metallic fibres, ceramic fibres, titanium dioxide, aluminum oxide, plaster, zirconium oxide, antimony oxide, clay, silica-alumina, sericite, diatomite, silica stone, carbon black, glassy hollow microspheres, red oxide, zinc oxide, and mixtures thereof.

26. The thermoplastic moulding composition according to claim 16, wherein component H) is at least one halogen-free flame retardant or at least one halogen-containing flame retardant.

27. The thermoplastic moulding composition according to claim 26, wherein the at least one halogen-free flame retardant or at least one halogen-containing flame retardant is selected from at least one member of the group consisting of phosphazenes, aliphatic or aromatic esters of phosphoric acid or polyphosphoric acid, metal phosphinates or phosphinic acid salts, bromine-containing flame retardants, chlorine-containing flame retardants, flame-retardant melamine compounds, benzoguanidine compounds or the salts thereof, allantoin compounds or the salts thereof, glycolurils or the salts thereof, cyanoguanidines, metal oxides such as antimony trioxide, antimony pentoxide, or sodium antimonate, phosphorus, such as red phosphorus, dicarboxylic acids of formula 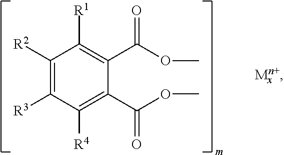
wherein
R¹ to R⁴ independently of one another represent halogen or hydrogen with the proviso that at least one radical R¹ to R⁴ represents halogen,
x=1 to 3,
m=1 to 9,
n=2 or 3,
M=alkaline earth metal, Ni, Ce, Fe, In, Ga, Al, Pb, Y, Zn, Hg,
functional polymers comprising 1,2-bis[4-(2-hydroxyethoxy)phenyl]ethanone repeating units and poly(2,6-dimethyl-1,4-phenyleneoxide) (PPO).

28. A process for producing the thermoplastic moulding composition according to claim 16 comprising the step of mixing the components A), B), C), D) and optionally E), optionally F), optionally G), optionally H) and optionally I).

29. A thermoplastic moulding composition according to claim 16 or obtained by a process for producing the thermoplastic moulding composition according to claim 16 comprising the step of mixing the components A), B), C), D) and optionally E), optionally F), optionally G), optionally H) and optionally I), for producing moulded articles, fibres, films and extruded articles.

30. A moulded or extruded article made of a thermoplastic moulding composition according to claim 16 or obtained by a process for producing the thermoplastic moulding composition according to claim 16 comprising the step of mixing the components A), B), C), D) and optionally E), optionally F), optionally G), optionally H) and optionally I).

31. The moulded or extruded article according to claim 30 being a high-voltage component.

32. The high-voltage component according to claim 31, selected from the group consisting of covers for electrics or electronics, control devices, covers/housings for fuses, relays, battery cell modules, fuse holders, fuse plugs, terminals, cable holders or sheathings.

33. A process for producing moulded or extruded articles made of a thermoplastic moulding composition according to claim 16 by injection moulding or extrusion of the thermoplastic moulding composition according to claim 16 or obtained by a process for producing the thermoplastic moulding composition according to claim 16 comprising the step of mixing the components A), B), C), D) and optionally E), optionally F), optionally G), optionally H) and optionally I).

34. The process according to claim 28 comprising:
i) mixing the components A), B), C), D) and optionally E), optionally F), optionally G), optionally H) and optionally I);
ii) extruding the composition obtained in step i) to give strands;
iii) cooling the strands obtained in step ii) until pelletizable, pelletizing and optionally drying; and
iv) subjecting the pelletized strands obtained in step iii) to further processing.

35. A thermoplastic moulding composition comprising at least one acid scavenger and i) at least one thermoplastic polyamide, ii) at least one of sodium hypophosphite or a hydrate of sodium hypophosphite and iii) a colourant comprising at least one not covalently bonded sulfur atom or two or more colourants comprising at least one sulfur containing colourant comprising at least one not covalently bonded sulfur atom, for improving the odour of said thermoplastic moulding compositions.
